(19) United States
(12) Patent Application Publication
(10) Pub. No.: US 2011/0176531 A1
(43) Pub. Date: Jul. 21, 2011

(54) Handling of Local Breakout Traffic in a Home Base Station

(75) Inventors: Johan Rune, Lidingo (SE); Jari Vikberg, Jarna (SE); Tomas Nylander, Varmodo (SE); Arne Norefors, Stockholm (SE)

(73) Assignee: TELEFONAKTIEBOLAGET L M ERICSSON (PUBL), Stockholm (SE)

(21) Appl. No.: 13/121,059

(22) PCT Filed: Jul. 9, 2009
(86) PCT No.: PCT/SE09/50884

§ 371 Date: Mar. 25, 2011

(30) Foreign Application Priority Data
Oct. 1, 2008 (US) 61101797

(51) Int. Cl. H04W 4/00

(52) U.S. Cl. 370/338

(57) ABSTRACT

The present invention relates to methods and devices that allow for efficient transportation of traffic in conjunction with a home base station (1). Traffic arriving in the home base station from a mobile terminal (2) connected to the home base station can be transported by means of local breakout transportation, which implies that the traffic is forwarded to a local node (4) over a local network (20) or to the Internet (21) without passing a core network (15) of a mobile telecommunications system. A local breakout bearer (22) is established, which is a radio bearer that extends between the mobile terminal and the home base station. The mobile terminal forwards uplink traffic that is to be subject to local breakout transportation to the home base station on the local breakout bearer. Thus it is not required for traffic that is destined for local nodes or the Internet to pass the core network, which allows for efficient traffic forwarding.

### TECHNICAL FIELD

The present invention relates to methods and arrangements in a telecommunications system with a home base station, and in particular to methods and arrangements for handling of traffic in connection with the home base station.

### BACKGROUND

In third generation UMTS systems (cf. 3GPP TS 23.002, “3rd Generation Partnership Project; Technical Specification Group Services and Systems Aspects; Network architecture (Release 8)”, December 2007) and in particular in its evolved version SAE/LTE (cf. 3GPP TS 23.401 v8.1.0 (also referred to as Evolved Packet System, EPS), “3rd Generation Partnership Project; Technical Specification Group Services and System Aspects; General Packet Radio Service (GPRS) enhancements for Evolved Universal Terrestrial Radio Access Network (E-UTRAN) access (Release 8)”, March 2008 and 3GPP TS 36.401 v8.1.0, “3rd Generation Partnership Project; Technical Specification Group Radio Access Network; Evolved Universal Terrestrial Radio Access Network (E-UTRAN); Architecture description (Release 8), March 2008), the concept of home base stations is introduced. In 3G a home base station is referred to as a Home Node B (HNB) whereas in EPS it is referred to as a Home eNode B (HeNB). A home base station is assumed to be placed in a private home, utilizing the home owner's fixed broadband connection to access a core network of mobile telecommunications system. It is also assumed that the home owner handles the actual physical installation of the home base station. Hence, the deployment of home base stations cannot be planned, since it is largely outside the control of an operator of the mobile telecommunications system. Another important property of the home base station concept is the potentially very large number of home base stations.

A home base station (such as a Home NodeB or Home eNodeB) connects to the operator's core network via a secure tunnel (supposedly IPsec protected) to a security gateway at the border of the operator's network. Via this tunnel the home base station connects to the core network nodes of the operator's core network (e.g. MME and S-GW via an 51 interface in EPS or SGSN and MSC (or MGW and MSC server) via an Iuinterface or Iuh interface in 3G UMTS). A 3GPP operator may also deploy a concentrator node in its network between the home base stations and the regular core network nodes. In the EPS standardization such a concentrator node is commonly referred to as a HeNB Gateway, which may be an optional node in EPS HeNB solutions. The corresponding node name in 3G UMTS standardization is HNB Gateway and this node is mandatory in 3G HNB systems.

For both EPS and 3G UMTS the home base station uses a broadband access network as (part of the) transport network. Possible Network Address Translators (NAT) between the home base station and the core network are not a problem for the secure tunnel when using, e.g. an Internet key Exchange Protocol (such as IKEv2), which can handle NAT traversal (i.e. activate UDP (User Datagram Protocol) encapsulation for EPS traffic as needed) and is assumed to be used for the secure tunnel establishment.

Furthermore, the user plane security, the RLC protocol, and the PDCP protocol are terminated in the RNC in 3G and in the eNode B in LTE. When a home base station is used, these protocols are terminated in the home base station (in the HNB, as the RNC functionality is placed in the HNB in the 3G HNB architecture, or in the HeNB in LTE), which makes user plane IP packets readily visible in the home base station.

Through this setup a User Equipment (UE, also referred to as a mobile terminal) can communicate via the home base station and the core network like any other UE. However, since the home base station is connected to its owner's broadband access (e.g. a broadband modem) it is potentially a part of a home LAN (also known as a local CPE network). The UE may thus potentially communicate with other devices connected to the home LAN, e.g. a printer or a computer. As a consequence the home base station related mechanisms must enable a UE to communicate both locally (with devices in the home LAN) and remotely (with devices outside of the home LAN) and it should preferably be possible to mix these two types of traffic and have both local and remote communication sessions ongoing simultaneously.

However, according to prior art solutions a home base station is not able to distinguish and give special treatment to traffic relating to local communication sessions compared to traffic relating to remote communication sessions. There is thus no way in existing home base station solutions to handle local and remote traffic differently in order to achieve more efficient traffic handling adapted to the specific type of traffic.

### SUMMARY

An object of the present invention is to provide methods and arrangements that allow for efficient transportation of traffic in a telecommunications system with a home base station.

The above stated object is achieved by means of methods and nodes according to the independent claims.

A basic idea of embodiments of the present invention is to enable different types of transportation of different types of uplink traffic from a mobile terminal via a home base station. The embodiments of the present invention enable local breakout transportation of traffic via the home base station, which means that traffic may be transported without passing a core network of a mobile telecommunications system. According to embodiments of the present invention a separate dedicated bearer is established between the mobile terminal and the home base station for traffic subject to local breakout transportation

A first embodiment of the present invention provides a method in a mobile terminal for forwarding of traffic. The mobile terminal has a radio connection to a home base station. The home base station has a connection to a local network with a number of local nodes, a connection to a core network of a mobile telecommunications system via an access network, and a connection to the Internet via the access network. The method includes a step of identifying uplink traffic to be subject to local breakout transportation. Local breakout transportation implies forwarding the uplink traffic to a local node and/or the Internet without passing the core network. The method also includes a step of communicating with the home base station using signaling to establish a dedicated local breakout bearer for traffic subject to local breakout transportation. The local breakout bearer is a radio bearer that extends between the mobile terminal and the home base station. According to the method, the identified uplink traffic is sent to the home base station on the established local breakout bearer.

A second embodiment of the present invention provides a method in a home base station for forwarding of traffic. The home base station has a connection to a mobile terminal over a radio interface, a connection to a local network with a number of local nodes, a connection to a core network of a mobile telecommunications system via an access network, and a connection to the Internet via the access network. The method includes a step of communicating with the mobile terminal using signaling to establish a dedicated local breakout bearer for traffic subject to local breakout transportation. As mentioned above, local breakout transportation implies forwarding the uplink traffic to a local node and/or the Internet without passing the core network. The local breakout bearer is a radio bearer that extends between the mobile terminal and the home base station. According to the method, the home base station receives uplink traffic from the mobile terminal on the established local breakout bearer and forwards the uplink traffic received on the local breakout bearer according to local breakout transportation.

A third embodiment of the present invention provides a mobile terminal for use in a mobile telecommunications system, The mobile terminal has a radio interface adapted for connection to a home base station, which is connected to a local network with a number of local nodes, a core network of the mobile telecommunications system via an access network, the Internet via the access network. The mobile terminal also comprises a processing unit that is adapted to identify uplink traffic to be subject to local breakout transportation. As mentioned above, local breakout transportation implies forwarding the uplink traffic to a local node and/or the Internet without passing the core network. The processing unit is furthermore adapted to communicate with the home base station using signaling to establish a dedicated local breakout bearer for traffic subject to local breakout transportation. The local breakout bearer is a radio bearer that extends between the mobile terminal and the home base station. The mobile terminal further comprises an output unit that is adapted to send the uplink traffic identified by the processing unit for local breakout transportation to the home base station on the established local breakout bearer.

A fourth embodiment of the present invention provides a home base station for use in a mobile telecommunications system. The home base station comprises a radio interface adapted for connection to at least one mobile terminal, as well as one or several interfaces adapted for connection to a local network comprising a number of local nodes, for connection to a core network of a mobile telecommunications system via an access network, and for connection to the Internet via the access network. The home base station further comprises a processing unit adapted to communicate with the mobile terminal using signaling to establish a dedicated local breakout bearer for traffic subject to local breakout transportation. As mentioned above local breakout transportation implies forwarding the uplink traffic to a local node and/or the Internet without passing the core network. The local breakout bearer is a radio bearer that extends between the mobile terminal and the home base station. The home base station also has an input unit adapted to receive uplink traffic from the mobile terminal on the established local breakout bearer and an output unit adapted to forward the uplink traffic received on the local breakout bearer according to local breakout transportation.

A fifth embodiment of the present invention provides an operation and maintenance node for use in an operation and maintenance system of a telecommunications system. The node comprises a control unit which is adapted to communicate with a home base station to enable or disable the home base station for local breakout transportation. Local breakout transportation implies forwarding traffic to a local node and/or the Internet without passing a core network of a mobile telecommunications system.

A sixth embodiment of the present invention provides a method in an operation and maintenance node of an operation and maintenance system of a telecommunications system. The method includes a step of sending control information to a home base station to enable or disable the home base station for local breakout transportation. Local breakout transportation implies forwarding traffic to a local node and/or the Internet without passing a core network of a mobile telecommunications system.

An advantage of embodiments of the present invention is that they can provide a mobile terminal (UE) connected to a home base station with the possibility of communicating locally with other nodes connected to a local network (e.g. a home LAN) to which the home base station is connected. During local communication traffic is transported by means of local breakout transportation which implies that the traffic does not pass a core network of a mobile telecommunications system (e.g. a 3GPP core network).

Another advantage of embodiments of the present invention is that when local breakout transportation of traffic is used latency experienced during local communication is drastically reduced.

Yet another advantage of embodiments of the present invention is that when local breakout transportation is used, the user experience during local communication is improved and the annoyance of having to live with traffic charges and long latencies for local communication is eliminated.

A further advantage of embodiments of the present invention is that when local transportation is used for some traffic, the core network of the mobile telecommunications system is offloaded (and if flat rate is used for the mobile telecommunication subscription such offloading does not reduce the operator's income).

Yet a further advantage of embodiments of the present invention is that they allow the mobile terminal connected to the home base station to communicate with or via the Internet without going via the core network of the mobile telecommunications system, i.e. local breakout transportation of Internet traffic. Thereby it is made possible to access the Internet via the home base station without 3GPP subscription traffic charges. This type of Internet access may also be experienced as faster by the user because of reduced overhead. The core network of the mobile telecommunications system is offloaded if local breakout transportation of Internet traffic is used. If flat rate is used for the mobile telecommunication subscription such offloading does not reduce the operator's income.

Further advantages and features of embodiments of the present invention will become apparent when reading the following detailed description in conjunction with the drawings.

### BRIEF DESCRIPTION OF THE DRAWINGS

FIG. 1 is a schematic block diagram which illustrates a first application scenario in which an embodiment of the present invention is implemented.

FIG. 2 is a schematic block diagram which illustrates a third application scenario in which an embodiment of the present invention is implemented.

FIG. 3 is a schematic block diagram which illustrates a fifth application scenario in which an embodiment of the present invention is implemented.

FIGS. 4 and 5 are schematic block diagrams illustrating control plane protocol stacks for a HeNB connected to a 3GPP EPS core network via a HeNB gateway and without a HeNB gateway respectively.

FIG. 6 is a schematic signaling diagram illustrating a procedure for establishment of a local breakout bearer, including different IP address allocation variants, according to a first type of embodiments of the present invention.

FIG. 7 is a schematic signaling diagram illustrating an alternative procedure for establishment of a local breakout bearer, including different IP address allocation variants, according to the first type of embodiments of the present invention.

FIG. 8 is a schematic signaling diagram illustrating a procedure for establishment of a local breakout bearer, including different IP address allocation variants, according to a second type of embodiments of the present invention.

FIG. 9 is a schematic signaling diagram illustrating an alternative procedure for establishment of a local breakout bearer, including different IP address allocation variants, according to the second type of embodiments of the present invention.

FIG. 10 is a schematic signaling diagram illustrating de-establishment of a local breakout bearer according to the second type of embodiments of the present invention.

FIGS. 11 and 12 are schematic signaling diagrams illustrating yet an alternative procedure for establishment of a local breakout bearer, including different IP address allocation variants, according to the second type of embodiments of the present invention.

FIG. 13 is a schematic signaling diagram illustrating a procedure for establishment of a local breakout bearer, including different IP address allocation variants, according to a stand-alone local breakout operation embodiment of the present invention.

FIG. 14 is a flow diagram illustrating a method in a mobile terminal for forwarding of traffic according to an embodiment of the present invention.

FIG. 15 is a flow diagram illustrating a method in a home base station for forwarding of traffic according to an embodiment of the present invention.

FIG. 16 is a schematic block diagram of a mobile terminal according to an embodiment of the present invention.

FIG. 17 is a schematic block diagram of an O&M node according to an embodiment of the present invention.

FIG. 18 is a schematic block diagram of a home base station according to an embodiment of the present invention.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like reference signs refer to like elements. A list summarizing abbreviations used throughout this description is provided at the end of this section.

As mentioned above according to prior art solutions a home base station will treat all traffic equally irrespective of whether the traffic relates to a local session (communication between a UE and devices in a local CPE network) or a remote session (communication between a UE and devices outside of the local CPE network). As a result a number of suboptimal situations may occur. When a UE connected to the home base station wishes to communicate with a local node, i.e. another node in the local CPE network, e.g. a network printer or user equipment for multi-player gaming, IP packets will be routed via a GGSN and Gi interface (for a HNB case) or a PDN Gateway and SGi interface (for a HeNB case) in a 3GPP core network. The home base station is not able to distinguish local CPE network traffic from global traffic. This is severely suboptimal in terms of both performance and resource utilization and the user may experience unreasonable delays. In addition, if the 3GPP operator charges the user for traffic between the UE and another node connected to the local CPE network (because the traffic has been routed via the 3GPP core network), the user will most likely be rather annoyed. Furthermore, if the nodes of the local CPE network are connected to the broadband access network via a Network Address Translator (NAT) (which is a common and likely scenario) they are not reachable from outside the NAT and consequently a UE communicating via the 3GPP core network (and the Gi or SGi interface) will not be able to initiate a communication session towards another node connected to the same local CPE network. If the UE also receives a private (non-routable) address from the 3GPP core network (which is sometimes the case in presently deployed GPRS/UMTS networks), then devices on the local CPE network will not be able to initiate communication sessions towards the UE, which would mean that the UE could not communicate with other nodes on the local CPE network at all (without the aid of an application level rendezvous server).

The same reasons that prevent local breakout of local CPE network traffic also prevent local breakout of Internet traffic via the broadband access network. It would be beneficial if a user would be able to choose to access the Internet via the broadband access network (and not via the 3GPP core network), while connected to the home base station and a home LAN like any other IP capable device connected to the home LAN. An incentive for this choice could be lower cost, since no potential charges from the 3GPP operator would incur for this traffic. Another incentive could be faster access, because of lower overhead in the Internet access which e.g. would be achieved by no IPsec tunnel and no core network to traverse before the Internet is reached. On the other hand, the user could not expect to receive any 3GPP based mobility support for such locally broken out Internet traffic.

For these reasons it would be beneficial to support local breakout for appropriately selected traffic in the home base stations, thereby confining local CPE network traffic to the local CPE network and enabling Internet traffic directly over the broadband access network without traversing the 3GPP core network.

Embodiments of the present invention make it possible for a UE connected to a home base station (e.g. a Home Node B or a Home eNode B) to communicate locally with other nodes connected to the local CPE network (e.g. a home LAN). Traffic between the UE and a node connected to the local CPE network is thus routed locally and not via the 3GPP core network whereby the latency that is experienced during local communication can be reduced and the user experience during local communication can be improved. It is also made possible by means of embodiments of the present invention to let the UE connected to the home base station to communicate with or via the Internet without involving the 3GPP core network in the transportation of the Internet traffic. When traffic is transported locally or to the Internet via the home base station without passing a core network of a mobile communications system (e.g. the 3GPP core network) this will be referred to herein as local breakout transportation or local breakout.

According to embodiments of the present invention explicit signaling between the UE and the home base station is used to establish a separate bearer for traffic that should be transported by means of local breakout transportation (i.e. without passing the core network). This separate bearer will be referred to as a local breakout bearer herein. The local breakout bearer carries the local breakout traffic between the UE and the home base station and has no continuation into the core network. Thus it is a fairly simple task for the home base station to separate local breakout traffic from traffic that should be transported to the core network. The real effort of separating local breakout traffic from non-local breakout traffic is placed in the UE, which is the most favorable place because the UE is the source of the uplink traffic where the user's intentions are most easily reflected.

The different embodiments described herein present several different options of how a local breakout bearer can be established using different types of signaling as well as several different options of how the local breakout traffic is transported using different address options and different scenarios. Many of the different options presented herein are independent of each other and can therefore be combined into a large number of different embodiments. According to a first alternative type of embodiments the local breakout bearer is established integrated in RRC signaling and according to another type of embodiments the local breakout bearer is established integrated in NAS signaling. The UE may e.g. use an IP address that the 3GPP core network has allocated to it for the local breakout traffic or use a separate IP address for the local breakout traffic as will be described in greater detail below. The home base station and UE may be used in several different scenarios which places different demands on traffic processing in the home base station in terms of e.g. NAT (Network Address Translation) and ALG (Application Level/Layer Gateway) functionality.

The following describes by means of examples some scenarios within which the present invention could be applied.

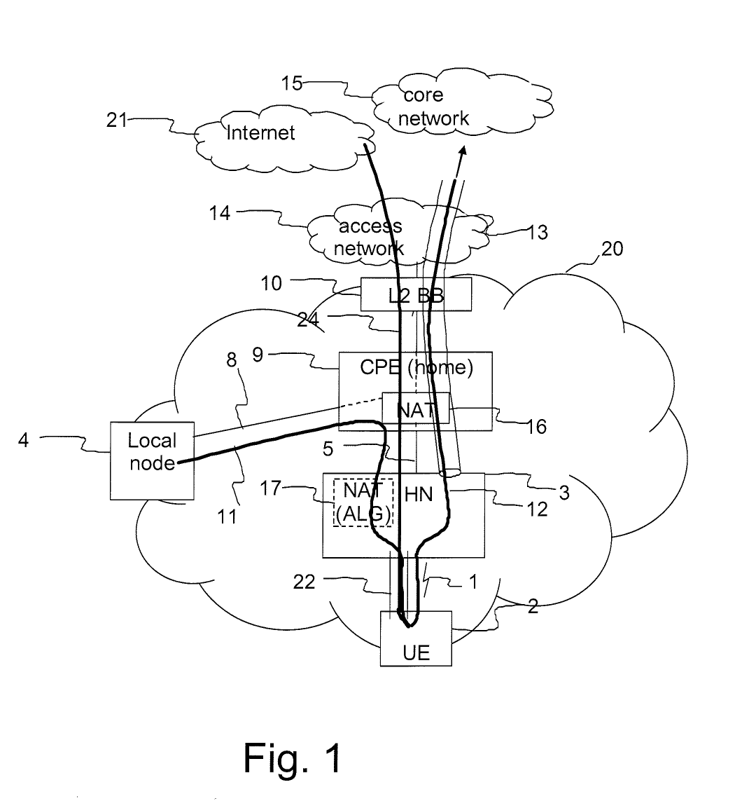

In a first scenario illustrated in FIG. 1 a home base station (HN) 1 is connected to a CPE (home) router 9 with a NAT 16 via an Ethernet/WLAN connection 5 and a number of local nodes 4 (only one local node illustrated for simplicity but can be any number) are connected to the CPE router 9 via Ethernet/WLAN connection 8. The local nodes 4 are allocated private (non-routable) IP addresses from the CPE router 9. The CPE router 9 is connected to a broadband access network 14 via a L2 broadband CPE 10, such as a broadband modem. In this first scenario, the broadband access network 14 allocates one public (globally routable) IP address (in this example an IPv4 address) to each broadband access subscriber, which means that the L2 broadband CPE 10 is allocated a single public IP address. The home base connects to a core network 15 (here a 3GPP core network) by means of an IPsec tunnel 13. The broadband access network can provide access to Internet 21 as well as to the core network 15. A UE 2 may connect to the home base station over a radio interface 3, which is a 3GPP radio interface in this case. The units which are assumed to be located in a home are part of a local CPE network 20 (also referred to as a local network herein).

In a second scenario, similar to the first scenario of FIG. 1, the local nodes 4 are connected the home base station via the 3GPP radio interface 3 instead of to the CPE router via Ethernet/WLAN connections. In other respects the first and second scenarios are alike. However this second scenario is considered unlikely and of lesser interest for the solutions according to the present invention since it probably would be reasonable in this scenario to let the UE 1 and a local node 4 communicate via the 3GPP core network 15, similar to communication between any other two 3GPP terminals.

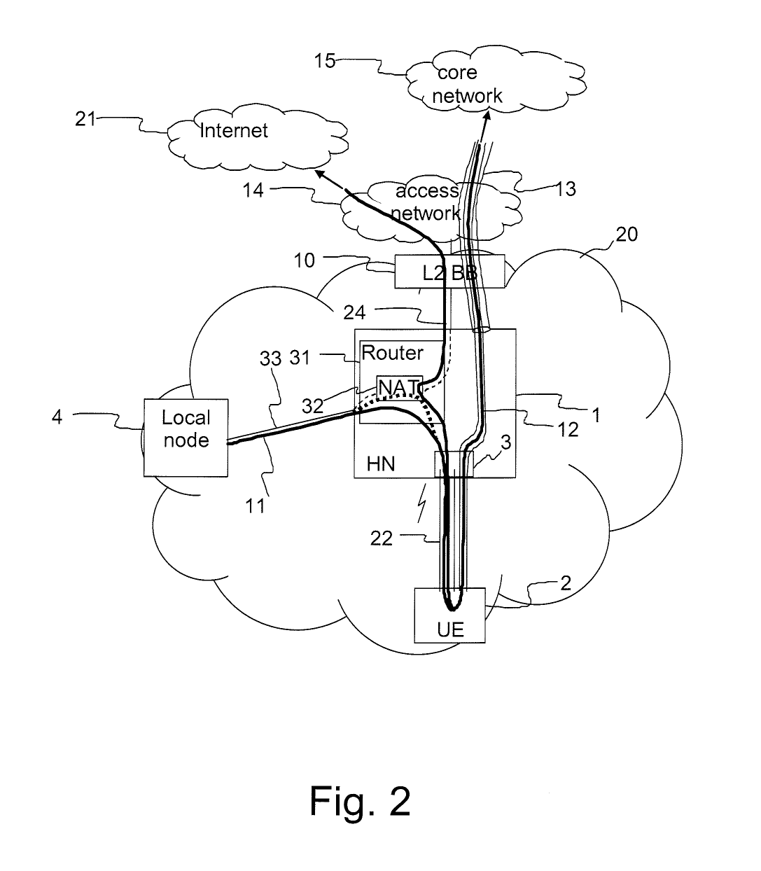

FIG. 2 illustrates a third scenario in which the home base station 1 is connected to a layer 2 broadband CPE 10, e.g. a cable modem or an xDSL (e.g. ADSL) modem, or is integrated with the layer 2 broadband CPE. The home base station 1 has an integrated router 31 with a NAT. Local nodes are connected to the home base station router 31 via Ethernet/WLAN connections 33. The broadband access network 14 allocates one public (globally routable) IP address to each broadband access subscriber. The local nodes 4 are allocated private (non-routable) IP addresses from the home base station router 31.

In a fourth scenario, the home base station is connected to a layer 2 broadband CPE 10, e.g. a cable modem or an xDSL (e.g. ADSL) modem, or is integrated with the layer 2 broadband CPE, like in the third scenario. However the local nodes 4 are connected to the home base station via the 3GPP radio interface 3. In other respects the third and fourth scenario are alike. Like the above mentioned second scenario, this fourth scenario is also considered unlikely and of lesser interest for the solutions according to the present invention since it probably would be reasonable in this scenario to let the UE 1 and a local node 4 communicate via the 3GPP core network 15, similar to communication between any other two 3GPP terminals.

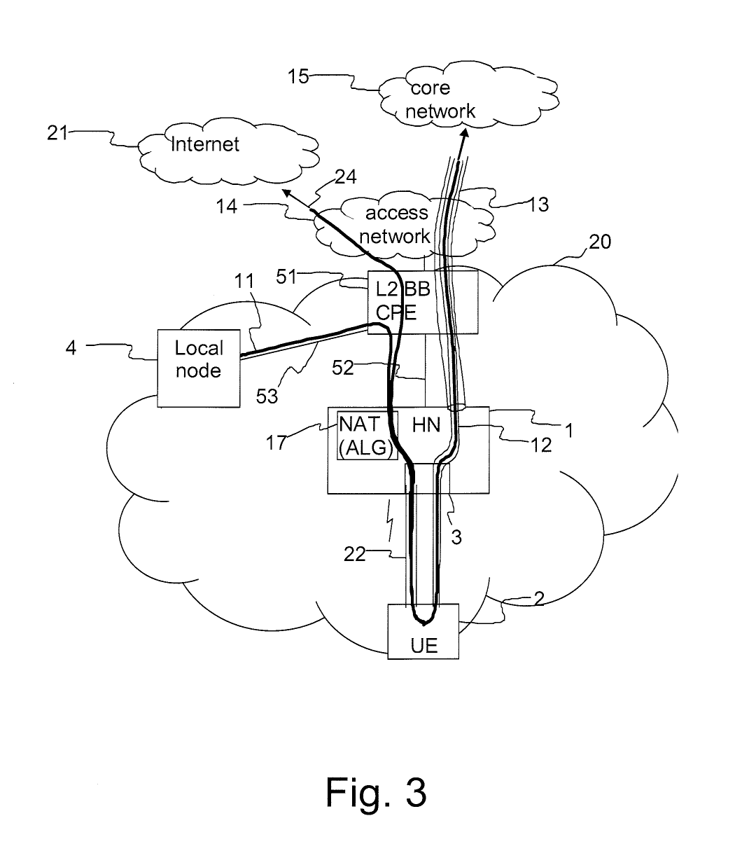

In a fifth scenario, illustrated in FIG. 3, the broadband access network 14 can allocate multiple public, globally routable IP addresses to multiple devices in the local CPE network 20. (This scenario deviates from the assumption of a single address allocated from the broadband access network which is valid for scenarios 1-4). The broadband CPE is a layer 2 broadband CPE 51 acting as a switch between the devices of the local network 20. The home base station 1 is connected to the layer 2 broadband CPE 51 via an Ethernet/WLAN connection 52. Local nodes 4 are connected to the layer 2 broadband CPE 51 via Ethernet/WLAN connections 53.

In the embodiments of the present invention which are described in detail herein it is assumed that the home base station 1 is a HeNBs, e.g., in LTE. However, the invention can also be adapted to 3G HNBs, using similar signaling but with the specific messages chosen from the 3G protocols, or other types of home base stations. This is further elaborated later.

A UE-HeNB specific protocol is utilized to allow the UE and the HeNB to explicitly agree on conditions for local breakout traffic. This allows flexibility for the UE/user and simple mechanisms for the HeNB while the 3GPP core network 15 can be kept completely uninvolved and unaware of the existence of local breakout traffic. A special (radio) bearer 22 for local breakout is utilized but this (radio) bearer has no continuation into the 3GPP core network 15.

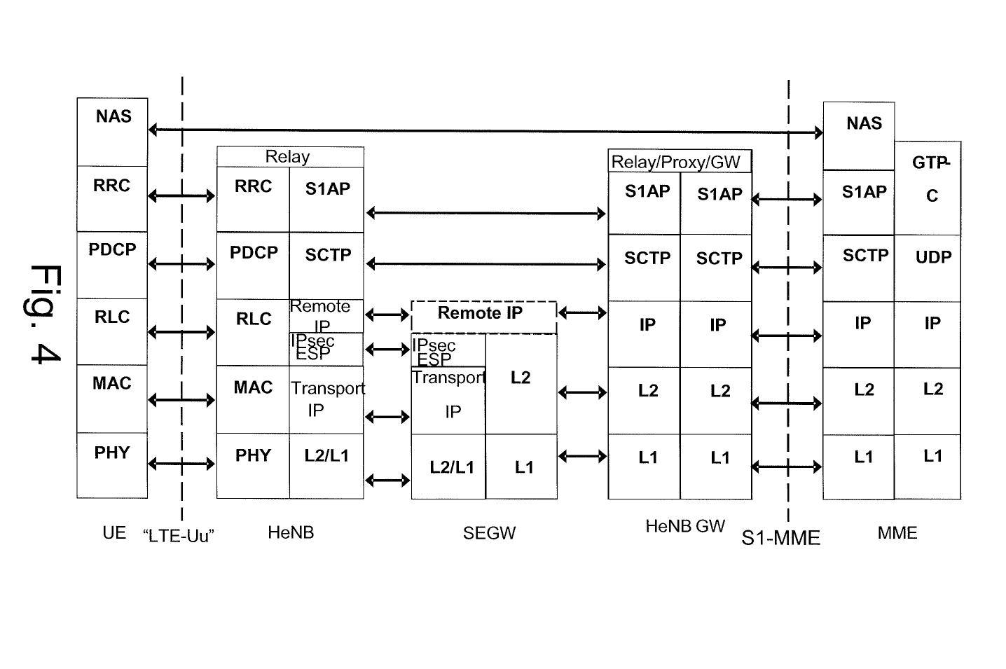

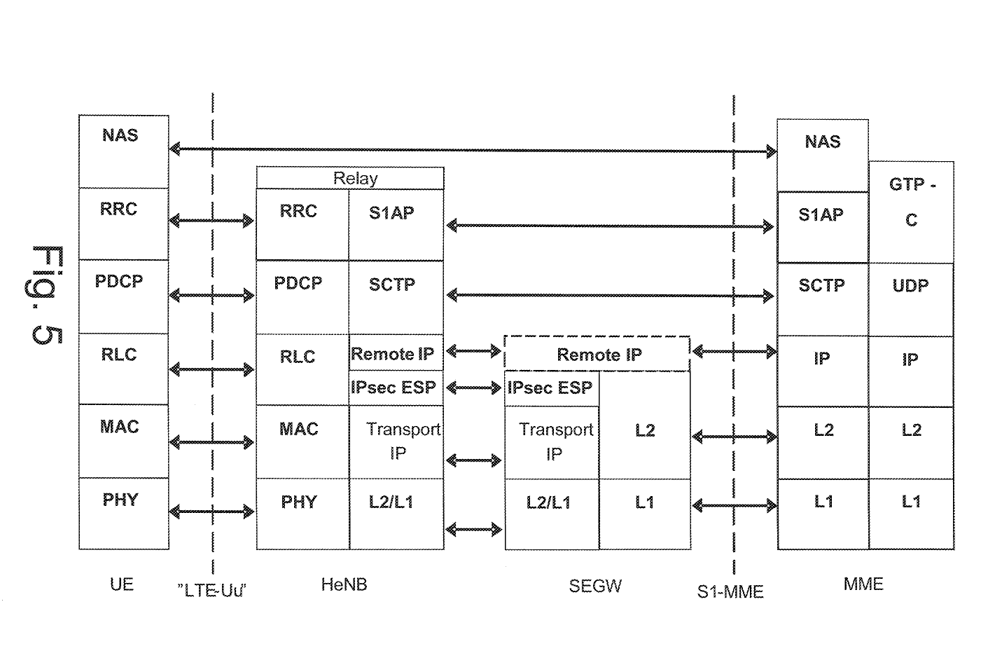

In order to provide a better understanding of the embodiments of the present invention described in detail herein, some relevant protocol stacks for a HeNB connected to a 3GPP EPS core network are illustrated in FIGS. 4 and 5. FIG. 4 illustrates control plane protocol stacks for a HeNB connected to the 3GPP EPS core network via a HeNB gateway (HeNB GW). FIG. 5 illustrates control plane protocol stacks for a HeNB connected to the 3GPP EPS core network without a HeNB GW. Two different types of embodiments of the present invention will now be described which differ in terms of the type of signaling used for establishing the local breakout bearer 22. According to the first type of embodiments RRC (Radio Resource Control) level signaling is used to establish the local breakout bearer 22. According to the second type of embodiments NAS (Non-Access Stratum) level signaling is used to establish the local breakout bearer 22. The part of a bearer which traverses the radio interface is often referred to as a “radio bearer”. As a consequence, the term “radio bearer” is often used in conjunction with the RRC protocol, which is used between the UE 2 and the HeNB 1, whereas the term “bearer” is used in conjunction with the NAS protocol, which is used between the UE 2 and an MME in the core network 15. In this document no other particular distinctions are associated with the terms “bearer” and “radio bearer” and these two terms may therefore in essence be interpreted as equivalent.

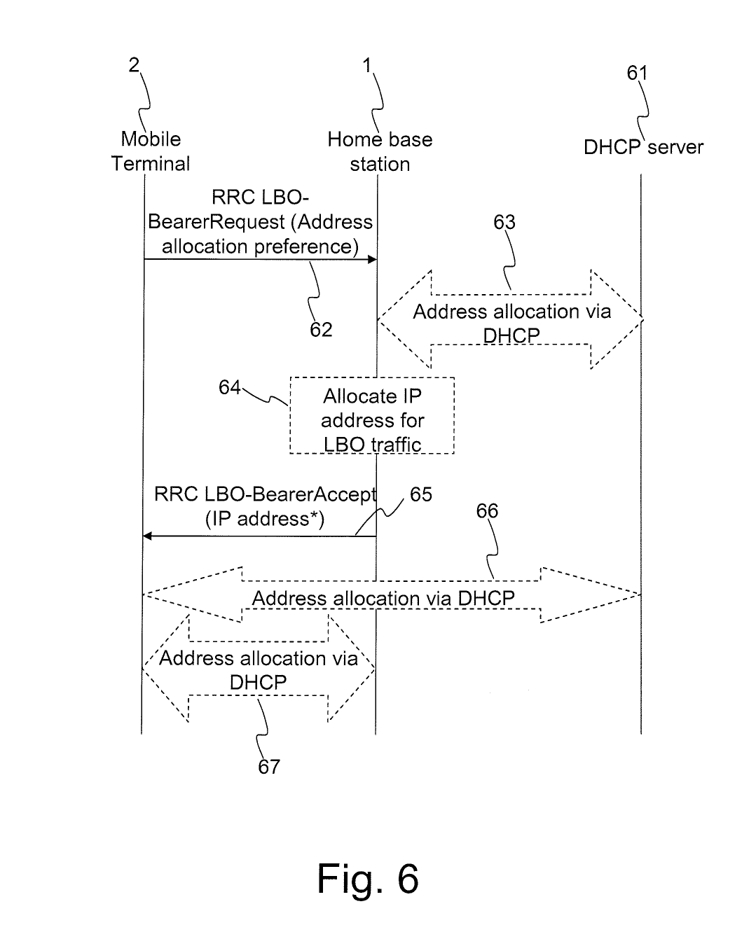

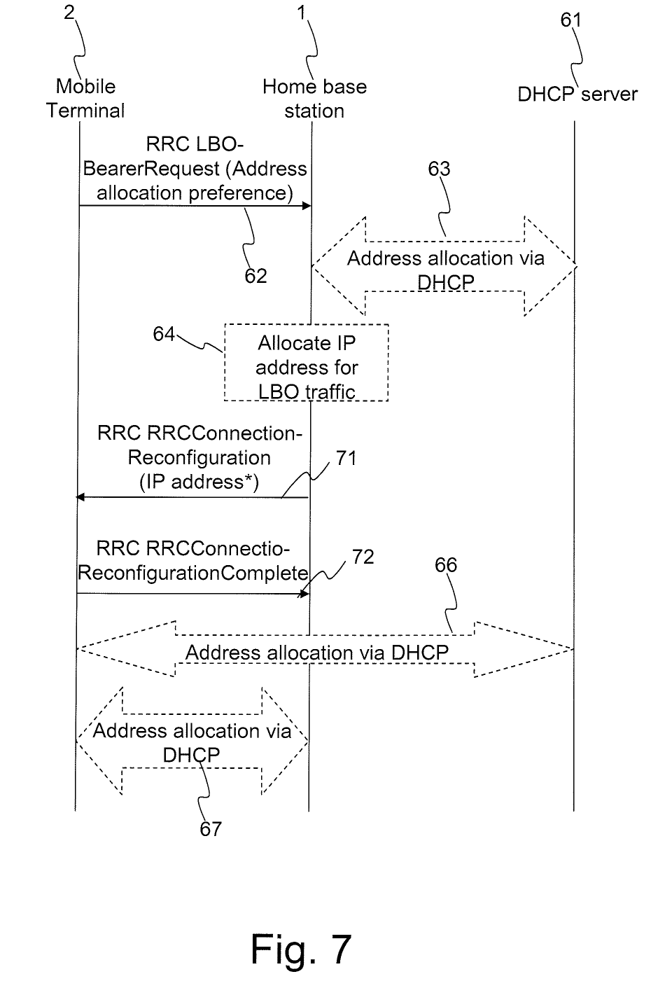

The following is a description of the process of establishing a radio bearer for local breakout traffic using RRC level signaling with reference to signaling diagrams illustrated in FIG. 6 and FIG. 7. The UE 2 decides that it wants some or all of its traffic to be broken out locally. This can be triggered, e.g. by a manual indication from a user or be concluded in accordance with configurations (e.g. some kind of “connectivity preferences”), which e.g. the user may have configured in the UE 2. The UE 2 then sends an RRC request message 62 to the home base station 1, indicating its desire to have a local breakout bearer 22 established. The RRC request message 62 may be a new message dedicated for this purpose, e.g. denoted RRC LBO-BearerRequest message, or an existing message, e.g. an RRC RRCConnectionRequest message or an RRC MeasurementReport message, with new types of indications. According to further embodiments, the UE could also indicate additional preferences in the RRC request message 62 such as:
Preference information indicating the type of traffic that the local breakout bearer is primarily intended for and conditions for its establishment. Such preference information may e.g. indicate that the local breakout bearer 22 is intended (primarily) for Internet traffic and that the local breakout bearer should be established only if local breakout transportation of Internet traffic can be arranged. Correspondingly, the preference information may indicate that the local breakout bearer 22 is intended (primarily) for local traffic between the UE 2 and local nodes 4 and that the local breakout bearer 22 should be established only if local breakout transportation of local traffic can be arranged. Alternatively, the preference information can indicate that the local breakout bearer should be established only if local breakout transportation of at least one of Internet traffic and local traffic can be arranged.
Preference information regarding IP address allocation preferences/capabilities. For instance:
(a) information that indicates that the UE 2 expects to get a dedicated IP address allocated for local breakout traffic. This can be done, e.g., by a method where the UE 2 uses DHCP (Dynamic Host Configuration Protocol) in the user plane (i.e. across the local breakout bearer 22) to acquire an IP address. A DHCP server allocating the dedicated IP address may then be located in the local CPE network 20 (e.g. a home router), in the broadband access network 14 or integrated in the home base station 1, depending on the scenario. According to another conceivable method, the UE 2 expects the home base station 1 to allocate an IP address for the local breakout traffic in a response 65 to the RRC request message 62. Depending on the detailed implementation of the methods the home base station 1 may have to act as a NAT for Internet traffic, local CPE network traffic, or both.
(b) information that the UE expects to use an IP address allocated from the 3GPP core network 15 also for local breakout traffic and thereby requiring NAT support in the home base station 1. It is here assumed that the IP address used should be an IPv4 address (and consequently the UE 2 may have to explicitly indicate to the 3GPP core network 15 that it wants an IPv4 address to be allocated, possibly in addition to an IPv6 address).

When the home base station receives the RRC request message 62 from the UE 2 to establish the local breakout bearer 22, it processes any specific preference/condition information in the request and, assuming that the home base station accepts the request, establishes the local breakout bearer 22 by creating appropriate internal context data and returning the response 65 to the UE. This response may be a dedicated RRC message, e.g. denoted RRC LBO-BearerAccept message, or an indication in an existing message (preferably then the message commonly used as a response message to the RRC message that was carrying the request, e.g. an RRC RRCConnectionSetup message in response to an RRC RRCConnectionRequest message). The response may include a status indication for each of the preferences/conditions expressed in the request (when appropriate), e.g. indicating whether local breakout transportation for local traffic or Internet traffic or both can be arranged and/or whether the home base station 1 can and will provide NAT functionality for the UE 2. If the UE 2 expects to receive an IP address for local breakout traffic from the home base station 1, the home base station 1 may include this IP address in its response 65 to the UE 2. To acquire this IP address the home base station may internally allocate a private address or retrieve it via DHCP from a DHCP server 61 located in the local CPE network 20 or the broadband access network 14, thereby acting as a sort of “DHCP client proxy” on behalf of the UE 2. Another alternative is that the UE's address allocation preferences/capabilities are conveyed to the home base station 1 in a RRC UECapabilityInformation message (in response to a RRC UECapabilitylnquiry message). Yet an alternative is to not convey any preferences related to the local breakout bearer 22 establishment from the UE 2 to the home base station 1 and to instead rely on default values. When a UE 2 is allocated a separate IP address for local breakout traffic, this IP address may be accompanied by other IP host configuration data, such as a subnet mask, a default gateway address and a DNS (Domain Name System) server address.

FIG. 6 illustrates the local breakout bearer establishment procedure and the different variants of allocation of the dedicated IP address for local breakout traffic described above.

When the local breakout bearer 22 is established without a dedicated IP address being allocated to the UE 2 for the local breakout traffic, then the establishment procedure may comprise sending the RRC request message 62 from the UE 2 to the home base station 1 and sending the response message 65 from the home base station 1 to the UE 2. In that case no address allocation preference information will be included in the request message 62 and no IP address will be included in the response message 65. In FIG. 6 it is illustrated that the RRC request message is a RRC LBO-BearerRequest and that the response message 65 is a RRC LBO-BearerAccept message, but these messages may also be other, existing messages, such as the RRC RRCConnectionRequest and RRC RRCConnectionSetup messages, carrying the local breakout bearer request and accept indications (and any associated parameters) in addition to their regular contents.

When a dedicated IP address for local breakout traffic is allocated to the UE 2 by a DHCP server 61 in the local CPE network 20 or the broadband access network 14, signaling will be carried out between the UE and the DHCP server as indicated by arrow 66 in FIG. 6. The RRC request message 62 will then include address allocation preference information that indicate that the UE expects to receive a dedicated IP address for the local breakout traffic by means of DHCP. In case the home base station 1 has an integrated DHCP server the UE may communicate with the home base station to receive the dedicated IP address via DHCP as indicated by arrow 67 in FIG. 6 instead of as indicated by arrow 66.

As mentioned above it is possible for the home base station 1 to act as a “DHCP client proxy” on behalf of the UE. In that case the address allocation preference information in the RRC request message 62 indicates that the UE expects to receive the dedicated IP address from the home base station. The home base station communicates via DHCP with the DHCP server 61 to receive the dedicated IP address on behalf of the UE as indicated by arrow 63 in FIG. 6. Another alternative is that the home base station 1 itself allocates the dedicated IP address for local breakout traffic to the UE 2 as indicated by box 64 in FIG. 6. The dedicated IP address, allocated by the DHCP server or the home base station, is then transferred from the home base station 1 to the UE 2 during the local breakout bearer establishment procedure, e.g. in the response message 65. The IP address conveyed to the UE 2 may be accompanied by other IP host configuration data, such as a subnet mask, a default gateway address and a DNS server address.

The local breakout bearer establishment procedure may also use a hybrid approach utilizing both new RRC messages and modified existing ones. According to such an approach the local breakout bearer establishment procedure may be initiated by e.g. a RRC LBO-BearerRequest 62, followed by a regular RRC connection reconfiguration procedure i.e. a regular RRC RRCConnectionReconfiguration message 71 from the home base station 1 to the UE 2, and a RRC RRCConnectionReconfigurationComplete message 72 from the UE 2 to the home base station 1, as shown in FIG. 7. The messages 71 and 72 would however be augmented with any necessary additional parameters such as, e.g., an allocated dedicated IP address for local breakout traffic or status indications for the home base station's local breakout capabilities. The different variants of allocating the dedicated IP address for local breakout traffic would correspond to those described in connection with FIG. 6 and are therefore not described in detail with respect to FIG. 7.

In the first scenario illustrated in FIG. 1 a DHCP server can be expected to be located in the CPE (home) router 9. (Even though the CPE (home) router 9 is referred to as a router herein it is able to function as a switch with respect to local traffic when an embodiment of the present invention is used as will be explained in further detail below.) The DHCP server in the CPE (home) router 9 can be used to provide the UE 2 with a dedicated IP (private) address for local breakout traffic if such a dedicated IP address is desired/expected. The UE 2 may communicate directly with the DHCP server via the local breakout user plane or the home base station 1 may communicate with the DHCP server on behalf of the UE and forward the allocated IP address to the UE 2 during the local breakout bearer establishment procedure as described above.

In the third scenario, illustrated in FIG. 2, the UE 2 has to be allocated a dedicated IP address for local breakout traffic from the home base station 1, if such a dedicated IP address is to be used. The reason for this is that the L2 broadband CPE 10 does not have a DHCP server and the broadband access network 14 will not allocate more than one address to the same access connection. If the UE 2 uses DHCP via the local breakout user plane to acquire this address, then the home base station 1 has to include a DHCP server. Otherwise, if the UE 2 expects to receive the address from the home base station 1 during the local breakout bearer establishment procedure (e.g. in the RRC LBO-BearerAccept message 65), then any internal address allocation mechanism in the home base station 1 will do.

If the UE 2 in the fifth scenario, illustrated in FIG. 3, is to be allocated a dedicated IP address for local breakout traffic, this address should preferably be allocated by the broadband access network 14. The UE 2 may itself retrieve the address via DHCP (in the local breakout user plane) from a DHCP server 61 in the broadband access network 14. Alternatively, the home base station 1 can acquire the address via DHCP from the broadband access network 14 DHCP server 61 (acting as a DHCP client proxy on behalf of the UE 2) and forward it to the UE 2 during the local breakout bearer establishment procedure (e.g. in the RRC LBO-BearerAccept message 65). Yet an alternative is that the home base station itself allocates the address to the UE 2, but then the home base station 1 must apply NAT functionality to the local breakout traffic and the benefit of a broadband access network that can allocate multiple routable addresses to the same local CPE network 20 (i.e. via the same subscriber access) is not utilized.

Once the local breakout bearer 22 has been established, the UE 2 can start sending (and receiving) traffic on the local breakout bearer 22 and processing of traffic received on the local breakout bearer commences in the home base station 1. This processing includes appropriate forwarding and possibly also additional functions such as NAT. The processing of the local breakout traffic depends on the scenario. According to the embodiments of the present invention, uplink traffic that is to be subject to local breakout transportation is in practice separated from traffic that is to pass the core network 15 already in the UE 2. This is due to that the embodiments of the present invention use a dedicated radio bearer 22 for the local breakout traffic. Thus the home base station knows that all uplink packets arriving on the local breakout bearer 22 should be broken out locally, i.e. be forwarded by means of local breakout transportation.

When the UE 2 has uplink data to send it has to select which bearer to send it on. All local breakout traffic is sent on the same bearer, i.e. the local breakout bearer 22, whereas non-local breakout traffic is sent on other regular bearers which continue through the 3GPP core network 15. Thus separation of local breakout traffic occurs when the UE 2 chooses the bearer to send each packet on. This can be realized
in a UE internal routing table,
as a source address selection mechanism (in case the UE 2 has a dedicated IP address for local breakout traffic),
using packet filter mechanisms (e.g. filter rules that are intended to be used e.g. for care-of address selection in conjunction with MIPv6), or
by applying any regular bearer selection mechanism that is anyway implemented in the UE 2.

The home base station 1 forwards all uplink packets received on the local breakout bearer 22 towards a local node 4 in the local CPE network 20 and/or the broadband access network 14 towards the Internet 21. In the downlink the home base station 1 forwards all packets from the local nodes 4 in the local CPE network 20 and/or the broadband access network 14 and the Internet 21 addressed to the UE 2 on the local breakout bearer 22. This includes packets with the UE's address (in case the UE 2 has a dedicated address for local breakout traffic) as destination address in the IP header or packets with the home base station's address as destination address and in accordance with a NAT state (in case the home base station applies NAT functionality to the local breakout traffic). The home base station may also forward broadcast and multicast traffic from the local CPE network 20 and/or the broadband access network 14 and the Internet 21 to the UE 2 via the local breakout bearer 22.

In some cases the home base station 1 has to apply NAT functionality to some or all the local breakout traffic. These cases include:
The UE 2 does not have a dedicated address for local breakout traffic. In this case the home base station 1 has to apply NAT functionality 17 (and preferably ALG functionality, e.g. for UPnP traffic) to all local breakout traffic in both the first scenario illustrated in FIG. 1 and in the fifth scenario illustrated in FIG. 3. In the third scenario illustrated in FIG. 2 the home base station 1 may apply NAT (and ALG) functionality 32 to all local breakout traffic, but it may also choose to distinguish between local CPE network 20 traffic and Internet 21 traffic and allow local CPE network traffic to and from the UE without applying NAT functionality 32.
The UE 2 has a dedicated (private) address for local breakout traffic allocated by the home base station 1. In this case the home base station 1 must apply NAT (and preferably ALG) functionality 17 to all local breakout traffic in the first and fifth scenarios illustrated in FIGS. 1 and 3 respectively. In the third scenario illustrated in FIG. 2 the home base station may apply NAT (and ALG) functionality 32 to all local breakout traffic, but preferably it should distinguish between local CPE network 20 traffic and Internet 21 traffic and apply NAT (and possibly ALG) functionality 32 only to Internet traffic. The home base station 1 may distinguish uplink local CPE network 20 traffic from uplink Internet 21 traffic by snooping the destination address in the IP header of the IP packets. If this address is one that it has itself allocated to a local node 4 on the local CPE network 20 (or alternatively, if this address is in the private address range), then the packet is classified as local CPE network traffic. For downlink traffic the classification of local CPE network traffic and Internet traffic can be done by similarly snooping the source address in the IP header of the packets, but more straightforward is to simply keep track of what interface the packet arrived at (i.e. packets arriving on the interface between the broadband access network 14 and the home base station 1 are classified as Internet traffic whereas packets arriving on any of the (non-3GPP) local interfaces are classified as local CPE network traffic).

If the UE 2 has acquired a dedicated address for the local breakout traffic from another source than the home base station 1 (i.e. allocated by another entity than the home base station 1), then the home base station does not have to provide any NAT (or ALG) functionality to the local breakout traffic. (This is however not applicable for the third scenario, because in that scenario the only entity that can allocate a dedicated address to the UE 2 is the home base station 1.) When the home base station 1 does not apply NAT functionality to the local breakout traffic, it may perform Proxy ARP on behalf of the UE 2 (i.e., the home base station may handle ARP signaling on behalf of the UE 2, e.g. when an ARP request for the UE's local breakout IP address arrives at the home base station 1, the home base station responds to the request on behalf of the UE 2 with its own hardware address (e.g. IEEE 802 MAC-48 address) in the ARP reply.

If the UE 2 is using an IPv6 address allocated from the 3GPP core network 15 (which should normally be easily avoided), the home base station 1 has to translate between IPv6 and IPv4 in addition to acting as a NAT for local breakout traffic.

The processing of local breakout traffic is schematically illustrated for the first, third and fifth scenarios in FIGS. 1-3. Local breakout traffic between the UE and a local node 4 is illustrated with a bold line 11, while local breakout traffic to/from the Internet is illustrated with a bold line 24. The traffic that passes the core network 15 (herein referred to as core transportation) is illustrated with a bold line 12.

If two (or more) UEs 2 are simultaneously connected to a home base station 1 they may communicate locally (i.e. without traversing the 3GPP core network 15 and the Internet 21) via their respective local breakout bearers 22. The home base station 1 may emulate a local broadcast segment for the UEs' local breakout traffic such that uplink packets from the local breakout bearer of one of the UEs can be forwarded in the downlink direction on the local breakout bearer of the other UE. Knowing the addresses used by the UEs, the home base station 1 can select the packets that are appropriate to forward in this manner. In the third scenario (see FIG. 2) the local breakout traffic between two UEs 2 connected to the home base station 1 may also be forwarded by the integrated router 31 (with the addressing limitations imposed by possible home base station NAT functionality 32 in the communication path). If only one of the UEs 2 has a local breakout bearer 22, the two UEs 2 (again with the addressing limitations imposed by possible NAT(s) 32 in the communication path) communicate with each other via the 3GPP core network 15 and the Internet 21 (or only via the 3GPP core network 15 if both UEs 2 use non-local breakout bearers).

It should not only be possible to establish local breakout bearers 22, but also to de-establish them. A local breakout bearer can be de-established using RRC signaling corresponding to the RRC signaling used for its establishment. That is, if dedicated RRC messages were used to establish the local breakout bearer 22, then dedicated RRC messages are preferably used to de-establish the local breakout bearer 22 and if indications in existing RRC messages were used to establish the local breakout bearer 22 then indications in corresponding existing RRC messages are preferably used to de-establish the local breakout bearer (but dedicated local breakout bearer de-establishment messages may be used also in this case). Either the UE 2 or the home base station 1 can initiate the local breakout bearer de-establishment procedure, by sending a de-establishment request and the receiving unit may respond by sending a message that indicates that the de-establishment is completed.

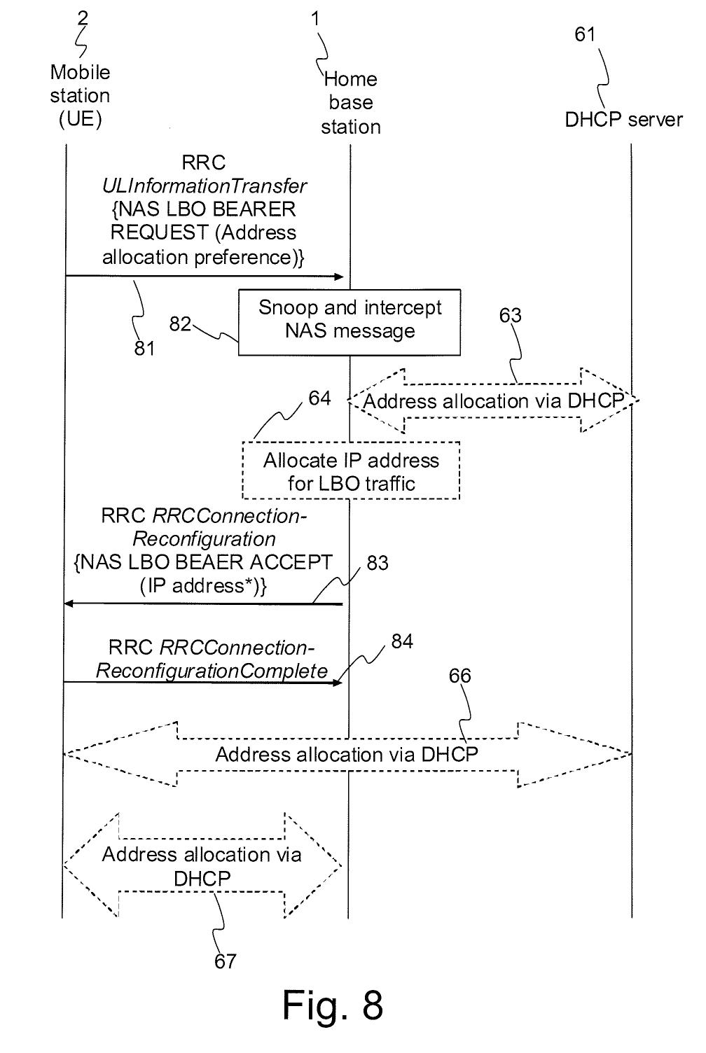

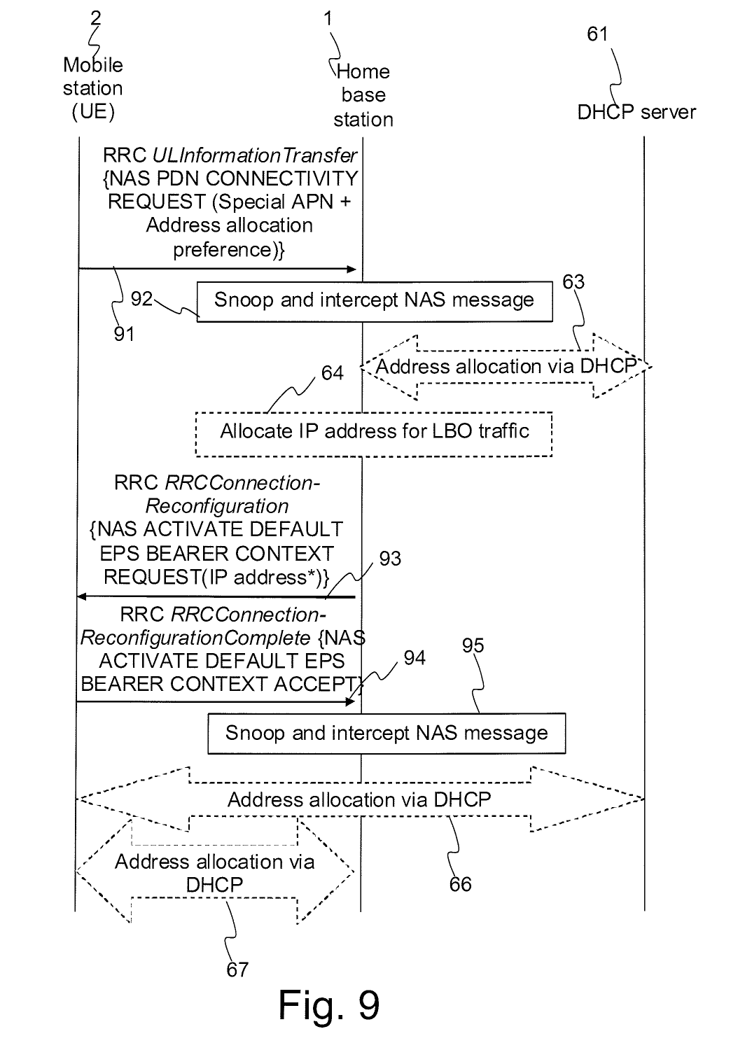

The process of establishing the local breakout bearer 22 using RRC level signaling according to a first type of embodiments of the present invention has been described above. Now the process of establishing the local breakout bearer 22 using NAS level signaling according to the second type of embodiments will be with reference to signaling diagrams illustrated in FIG. 8 and FIG. 9. In these figures the notation “RRC Message {NAS MESSAGE}” indicates that a NAS message is carried in a RRC message.

NAS level signaling is the normal signaling level for UE 2 bearer requests; however, the NAS signaling is normally performed between the UE 2 and an MME in the 3GPP core network 15. Therefore, in order to avoid involving the 3GPP core network 15 in the local breakout bearer establishment procedure, the home base station 1 intercepts any NAS message from the UE 2 that is related to local breakout bearers 22 and emulates the MME for the local breakout bearer related NAS message exchange. Intercepted messages are not forwarded to the MME in the 3GPP core network 15. Hence, the home base station 1 has to snoop the headers of uplink NAS messages in order to identify local breakout bearer related NAS messages. Utilizing different NAS messages to request the LBO bearer can be done according to different alternative variants. The differences between local breakout bearer establishment according to this second type of embodiments and the previously described first type of embodiments lie in the establishment and de-establishment of the local breakout bearer, but not in the processing of local breakout traffic. Therefore, the processing of the local breakout traffic will be as described above, irrespective of whether the local breakout bearer was established using RRC level signaling or NAS level signaling.

Just as described for the first type of embodiments, it is possible also in variants of the second type of embodiments to use the RRC UECapabilityInformation message to convey IP address allocation preferences or to rely on default preference values.

According to a first variant of the second type of embodiments illustrated in FIG. 8, a new NAS request message 81 (labeled, e.g., “NAS LBO BEARER REQUEST”) is dedicated for the purpose of establishing a bearer for local breakout traffic. This new NAS request message 81 can contain any of the above mentioned parameters related to local breakout bearer establishment such as IP address allocation preferences, etc. The home base station 1 snoops and intercepts 82 the NAS request message 81 and responds with a new corresponding NAS response message 83, e.g. labeled “NAS LBO BEARER ACCEPT”, which may contain local breakout bearer establishment related parameters as described above for the first type of embodiments, e.g. an IP address dedicated for local breakout traffic. The NAS request message 81 also triggers the home base station 1 to initiate an RRC connection reconfiguration procedure exchanging messages 83 and 84 as shown in FIG. 8. This variant provides the simplest way for the home base station 1 to identify a NAS message, which contains a request for a local breakout bearer 22 and which therefore should be intercepted and not forwarded to the MME and the 3GPP core network 15. The home base station 1 only has to check the message type field (which always is the second octet of a NAS message) of the uplink NAS messages and trigger interception when the message type matches the message type value for the new local breakout bearer request message (e.g. “NAS LBO BEARER REQUEST”). The different IP address allocation options that are available according to the previously described first type of embodiments are also available in connection with the second type of embodiments. The only difference is that any address allocation preference information and dedicated IP address (if requested) are included in NAS messages instead of at RRC level. Therefore the same reference numerals are used in FIG. 8 and FIG. 9 for IP allocation procedural steps as in FIG. 6 and FIG. 7. For a detailed description of these steps reference is made to the description above in connection with the first type of embodiments.

De-establishment of a local breakout bearer 22 according to this first variant of the second type of embodiments may be triggered by a new dedicated NAS message, e.g. labeled “NAS LBO BEARER DE-ESTABLISHMENT REQUEST”. This message can be sent by either the UE 2 or the home base station 1. The party receiving the message may respond with an acknowledgement message, e.g. labeled “NAS LBO BEARER DE-ESTABLISHMENT ACK”, but this acknowledgement message may also be omitted. The procedure also triggers the RRC connection reconfiguration procedure. A local breakout bearer 22 may also be de-established, if the home base station 1 receives an indication from the 3GPP core network 15 (i.e. the MME) that the UE 2 has been disconnected from all packet data networks.

According to a second variant of the second type of embodiments illustrated in FIG. 9, the UE 2 uses an existing NAS PDN CONNECTIVITY REQUEST message 91 to request establishment of the local breakout bearer 22. To indicate that the NAS request message 91 is a local breakout bearer request the UE 2 uses a dedicated APN value which is included in the NAS request message 91 (along with any preference information such as address allocation preference information or information on conditions for establishment). The special APN value will either be pre-configured in the UE 2 or downloaded to a USIM (Universal Subscriber Identity Module) of the UE using

Over-The-Air USIM configuration technology. The NAS request message 91 is snooped by the home base station 1 in a step 92 as illustrated in FIG. 9. In the home base station 1 the special APN value is either pre-configured (or even hard-coded) or configured through O&M means when the home base station 1 is installed. Less preferable alternatives to the special APN value would be to use a dedicated EPS bearer identity (which would have to be pre-configured or downloaded like the special APN value) or to introduce a new message parameter, an local breakout bearer request indication, to indicate the local breakout bearer request in the NAS PDN CONNECTIVITY REQUEST message. The NAS PDN CONNECTIVITY REQUEST message may possibly also be augmented to contain any of the above mentioned parameters related to local breakout bearer establishment, such as IP address allocation preferences, etc.

Triggered by the special APN value (or by the dedicated EPS bearer identity or the explicit local breakout bearer request indication) the home base station 1 intercepts 92 the NAS PDN CONNECTIVITY REQUEST message from the UE 1 (and does not forward it to the 3GPP core network 15 and the MME). To mimic the MME the home base station 1 responds with a NAS ACTIVATE DEFAULT EPS BEARER CONTEXT REQUEST message 93, in which the home base station 1 includes an EPS bearer identity and possibly parameters associated with the local breakout bearer establishment, such as an IP address for local breakout traffic. The UE 2 in turn responds with a NAS ACTIVATE DEFAULT EPS BEARER CONTEXT ACCEPT message 94 which is also intercepted by the home base station in a step 95. This procedure also triggers the RRC connection reconfiguration procedure.

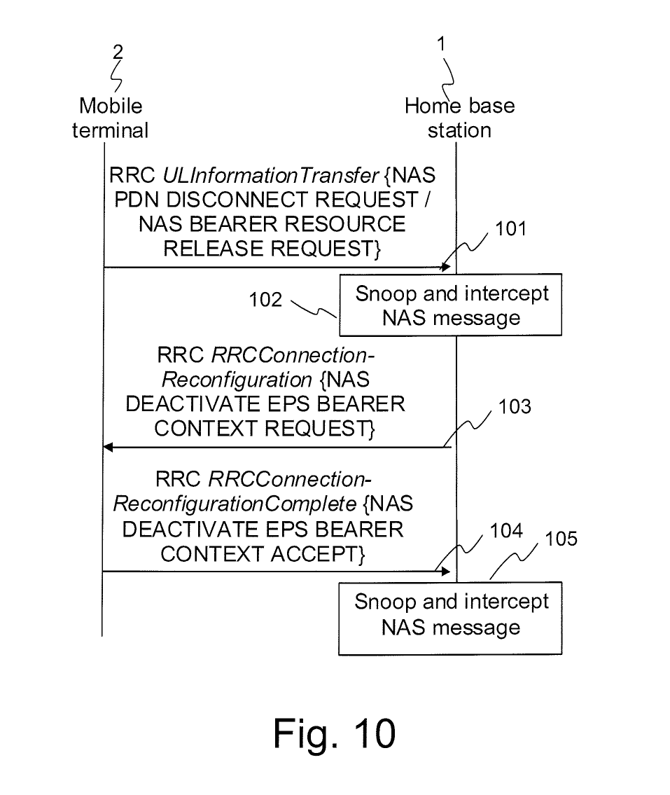

De-establishment of the local breakout bearer that has been established according to this second variant of the second type of embodiments may be done by sending a NAS PDN DISCONNECT REQUEST or NAS BEARER RESOURCE RELEASE REQUEST message 101 including the EPS bearer identity (or linked EPS bearer identity) previously received in the NAS ACTIVATE DEFAULT EPS BEARER CONTEXT REQUEST message 93 as illustrated in FIG. 10. The home base station 1 snoops the NAS message 101, recognizes the EPS bearer identity (or linked EPS bearer identity) that it previously sent to the UE 2 and intercepts the message (and does not forward it to the 3GPP core network and the MME) as illustrated by a step 102. Mimicking the MME for the intercepted message the home base station 1 is triggered to initiate a deactivate EPS bearer context procedure. Hence, the home base station 1 sends a NAS DEACTIVATE EPS BEARER CONTEXT REQUEST message 103 to the UE 2, which responds with a NAS DEACTIVATE EPS BEARER CONTEXT ACCEPT message 104, which is also intercepted 105 by the home base station 1.

It is also possible for the home base station 1 to initiate the local breakout bearer de-establishment without a prior trigger from the UE 2 in this second variant of the second type of embodiments. In such case the home base station 1 initiates the deactivate EPS bearer context procedure as described above, but without having received a preceding NAS PDN DISCONNECT REQUEST or NAS BEARER RESOURCE RELEASE REQUEST message 101 from the UE. As above, the deactivate EPS bearer context procedure consists of a NAS DEACTIVATE EPS BEARER CONTEXT REQUEST message 103 from the home base station 1 followed by a responding NAS DEACTIVATE EPS BEARER CONTEXT ACCEPT message 104 from the UE 2. The procedure also triggers the RRC connection reconfiguration procedure.

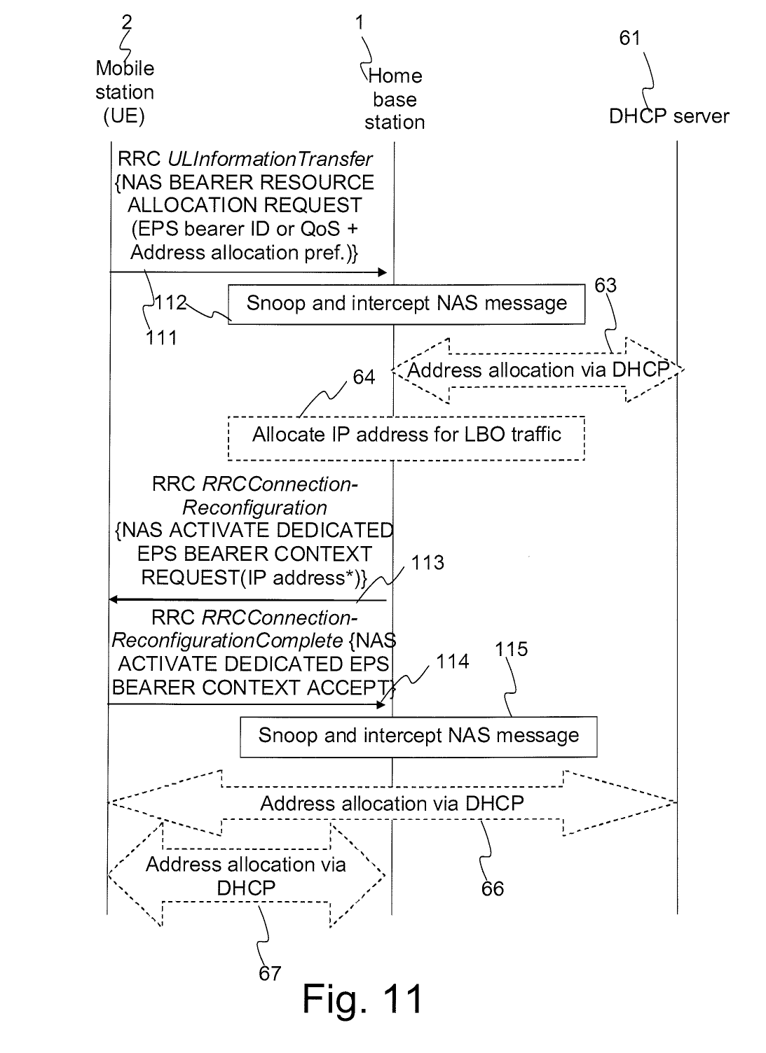

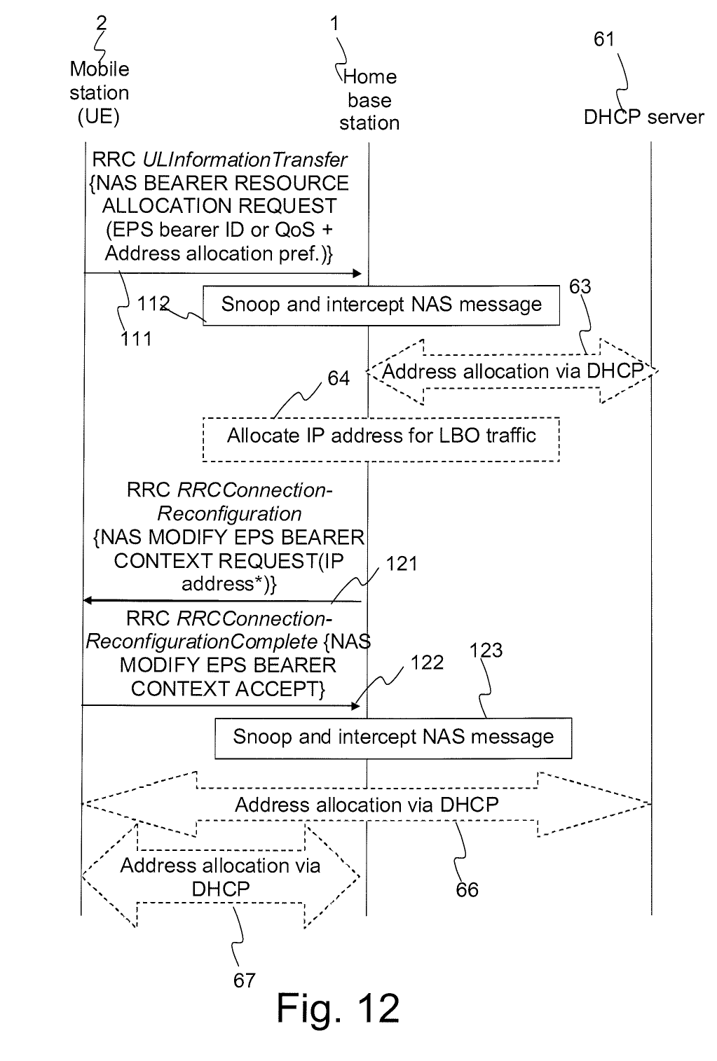

According to a third variant of the second embodiment illustrated in FIG. 11 and FIG. 12, the UE 2 uses a NAS BEARER RESOURCE ALLOCATION REQUEST message 111 to request the local breakout bearer 22. To indicate that the request concerns a local breakout bearer 22 the UE 2 includes a dedicated value of an EPS bearer identity in the NAS request message 111. This dedicated value is pre-configured in the UE 2 or downloaded to the USIM using Over-The-Air USIM configuration technology. In the home base station 1 the dedicated value is either pre-configured (or even hard-coded) or configured through O&M means when the home base station 1 is installed. An alternative to using a dedicated EPS bearer identity is to use a special QoS indication, which the home base station 1 interprets as a request for a local breakout bearer 22. Yet another alternative is to introduce an explicit local breakout bearer request indication in the NAS BEARER RESOURCE ALLOCATION REQUEST message 111. The NAS BEARER RESOURCE ALLOCATION REQUEST message 111 may possibly also be augmented to contain any of the above mentioned parameters related to local breakout bearer establishment, such as IP address allocation preferences, etc.

The home base station 1 snoops 112 the NAS BEARER RESOURCE ALLOCATION REQUEST message 111, determines that it is a request for an local breakout bearer and hence does not forward the message to the 3GPP core network 15 and the MME. Instead the home base station mimics the MME by initiating either a dedicated EPS bearer context activation procedure as illustrated in FIG. 11 or an EPS bearer context modification procedure as illustrated in FIG. 12. In the former case the home base station 1 sends a NAS ACTIVATE DEDICATED EPS BEARER CONTEXT REQUEST message 113 to the UE 2 (possibly including parameters associated with the local breakout bearer establishment, such as an IP address for local breakout traffic), to which the UE 2 responds with a NAS ACTIVATE DEDICATED EPS BEARER CONTEXT ACCEPT message 114 (which is intercepted 115 by the home base station). In the latter case the home base station 1 sends a NAS MODIFY EPS BEARER CONTEXT REQUEST message 121 (possibly including parameters associated with the local breakout bearer establishment, such as an IP address for local breakout traffic) to the UE 2, which responds with a NAS MODIFY EPS BEARER CONTEXT ACCEPT message 122 (which is intercepted 123 by the home base station 1). The activated NAS procedure (i.e. the dedicated EPS bearer context activation procedure or the EPS bearer context modification procedure) also triggers a RRC connection reconfiguration procedure. In both FIG. 11 and FIG. 12 all the different IP address allocation options previously described in conjunction with other embodiments are illustrated.

In this third variant of the second type of embodiments de-establishment of local breakout bearers is performed in the same way as described above in conjunction with the second variant of the second type of embodiments with reference to FIG. 10.

The different embodiments described above may be used when the UE 2 has at least a default bearer to the 3GPP core network 15. However these embodiments may also be adapted for stand-alone local breakout operation, i.e. without the UE 2 attaching to the 3GPP core network 15 and thus without any bearer to the 3GPP core network 15. In order to make the above described first types of embodiments of the present invention stand-alone local breakout solutions, it is sufficient that the UE 2 refrains from sending a NAS ATTACH REQUEST message after establishing an RRC connection to the home base station 1 (i.e. the UE does not include a NAS ATTACH message in a RRC RRCConnectionSetupComplete message which is normally the case). Instead, following the RRC RRCConnectionSetupComplete message (which normally concludes the random access procedure) the UE 2 initiates the local breakout bearer 22 establishment as described above, i.e. it sends its request for a local breakout radio bearer 22 to the home base station 1, either in a new dedicated RRC message 62 (e.g. denoted RRC LBO-BearerRequest) or included in an existing RRC message (which may even be the RRC RRCConnectionSetupComplete message), to the home base station 1. The home base station 1 then continues the local breakout radio bearer establishment as already described.

The above described second types of embodiments may be adapted for stand-alone local breakout operation by letting the home base station 1 intercept the attach procedure, refrain from forwarding the concerned uplink NAS messages to the 3GPP core network 15 and instead mimic the MME during the procedure. To enable this, the UE 2 should indicate to the home base station 1 that the attach procedure concerns stand-alone local breakout operation. A straightforward method is to introduce a new value for the EPS attach type IE in a NAS ATTACH REQUEST message, which the UE 2 sends (together with a NAS PDN CONNECTIVITY REQUEST message), when it initiates the attach procedure. The value of the EPS attach type IE consists of three bits. This enables eight different values, but only four values are currently defined. On reception of an EPS attach type IE with one of the four undefined values, the network (i.e. the MME) should use the default interpretation “initial attach”. The new “stand-alone local breakout operation attach” type would occupy one of the four currently unused values. When the home base station 1 snoops the NAS messages, it would recognize the message type of the NAS ATTACH REQUEST message and then, triggered by this message type, check the value of the EPS attach type IE. If it finds that this IE indicates “stand-alone local breakout operation attach”, the home base station 1 intercepts both the NAS ATTACH REQUEST and the NAS PDN CONNECTIVITY REQUEST message (which the UE 2 sends together with the NAS ATTACH REQUEST message) and refrains from forwarding them to the 3GPP core network 15 (and the MME). Instead the home base station 1 mimics the MME by responding to the received NAS message and initiating the default EPS bearer context activation procedure. That is, the home base station 1 sends a NAS ACTIVATE DEFAULT EPS BEARER CONTEXT REQUEST message together with a NAS ATTACH ACCEPT message. The UE 2 responds with a NAS ACTIVATE DEFAULT EPS BEARER CONTEXT ACCEPT message together with a NAS ATTACH COMPLETE message. These two message are also intercepted (and not forwarded) by the home base station 1 and thus the attach procedure for stand-alone local breakout operation is concluded. As previously described, the default EPS bearer context activation procedure also triggers the RRC connection reconfiguration procedure, which concludes the establishment of the local breakout bearer 22. Parameters related to the local breakout bearer establishment (if any), such as IP address allocation preference, could be included in either the NAS ATTACH REQUEST message or the NAS PDN CONNECTIVITY REQUEST message and the home base station 1 could include such parameters (if any), e.g. an IP address, in either the NAS ATTACH ACCEPT or the NAS ACTIVATE DEFAULT EPS BEARER CONTEXT REQUEST message.

When the UE 2 uses a new EPS attach type value in the NAS ATTACH REQUEST message, then the home base station 1 should preferably use a corresponding new value of the EPS attach result IE, indicating “stand-alone local breakout operation attach”, in the NAS ATTACH ACCEPT message. Also the value of the EPS attach result IE consists of three bits, enabling eight values, out of which currently only four are defined, so one of the four unused values can be used for the new indication. If none of the initial NAS messages (i.e. NAS ATTACH REQUEST and NAS PDN CONNECTIVITY REQUEST) is augmented with parameters related to the local breakout bearer 22 establishment (and instead an RRC UECapabilityInformation message or default values are used), then this method advantageously provides for smooth backwards compatibility with home base stations 1 that do not support local breakout (at least not this local breakout solution). If the home base station 1 does not intercept the NAS ATTACH REQUEST and NAS PDN CONNECTIVITY REQUEST messages (triggered by the new EPS attach type value), then the messages are forwarded to the MME as usual. The MME will interpret the EPS attach type value using the default interpretation “initial attach”, initiate the default EPS bearer context activation procedure and send a NAS ATTACH ACCEPT message to the UE 2, including the “initial attach” indication in the EPS attach result IE. From this value of the EPS attach result IE, the UE 2 can conclude that the home base station 1 did not support the request for stand-alone local breakout operation and that the UE's uplink NAS messages were forwarded to the MME. The UE 2 can then choose to either continue and accept that a bearer to the 3GPP core network 15 is established or detach from the network.

Furthermore, the above described three variants of the second type of embodiments of the present invention may be used to suppress the attachment to the core network 15, as the local breakout bearer 22 is established, hence resulting in stand-alone local breakout operation.

When the first variant of the second type of embodiments is used for establishment of stand-alone local breakout operation, the UE 2 omits the NAS ATTACH REQUEST message altogether and instead includes the new dedicated NAS message for local breakout bearer request in the RRC RRCConnectionSetupComplete message (where normally the NAS ATTACH REQUEST message would be included).

When the second variant of the second type of embodiments is used for establishment of stand-alone local breakout operation, the UE 2 includes a special APN value, a dedicated EPS bearer identity, or a new explicit message parameter in the NAS PDN CONNECTIVITY REQUEST message to indicate that stand-alone local breakout operation is requested. The UE 2 should include this indication in the NAS PDN CONNECTIVITY REQUEST message that is sent together with the NAS ATTACH REQUEST message.

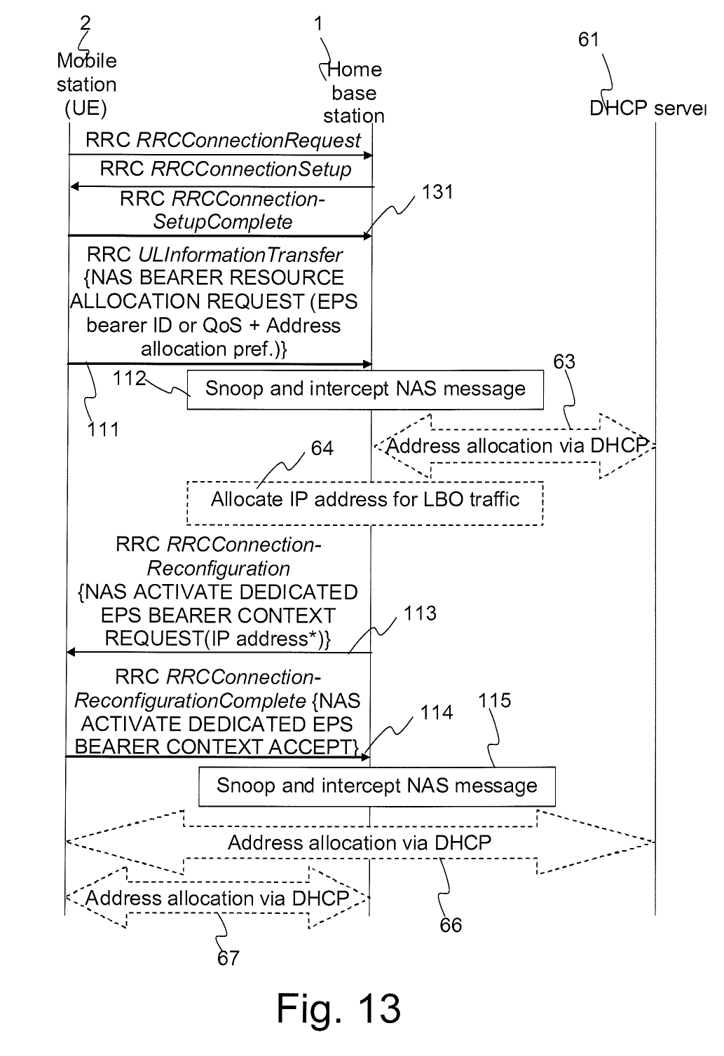

It is also possible to use the third variant of the second type of embodiments to establish stand-alone local breakout operation. In such case the UE 2 would not include any NAS ATTACH REQUEST message in a RRC RRCConnectionSetupComplete message 131 (and no NAS PDN CONNECTIVITY REQUEST messages either). Instead it would include the NAS BEARER RESOURCE ALLOCATION REQUEST message (with either a dedicated EPS bearer identity or a special QoS indication) in the RRC RRCConnectionSetupComplete message. Alternatively, the UE 2 could include no NAS message at all in the RRC RRCConnectionSetupComplete message 131 and instead subsequently send the NAS BEARER RESOURCE ALLOCATION REQUEST message in a RRC ULInformationTransfer message, which is illustrated in FIG. 13.

The above described realizations of local breakout operation without UE attachment to the 3GPP core network 15 result in a situation similar to an open WLAN, i.e. a WLAN without encryption and authentication. This may be acceptable in some applications, but in other applications a higher degree of security may be desired. Authentication and radio interface encryption requires involvement of the 3GPP core network 15. Normally, the 3GPP core network performs an authentication procedure based on a shared secret in the USIM and the AuC/HSS and encryption keys are generated in the process. However, involving the 3GPP core network 15 is in a sense contradictory to the goal of establishing local breakout traffic without attachment to the 3GPP core network 15. One option for achieving a higher degree of security that is feasible without involving the 3GPP core network 15 is to enable IMSI based access control in the home base station 1. Two conditions must be fulfilled: a list of subscribers that are allowed to access the home base station 1 stored in the home base station 1 and the IMSI must be conveyed from the UE 2 during or prior to the local breakout bearer establishment. The first condition is fulfilled if the home base station access list (which is defined by the owner of the home base station 1) is either entered directly into the home base station 1 (by the home base station owner) or transferred from an O&M entity which holds the owner-defined access list (and which may be entered into the O&M entity e.g. via a web interface). To fulfill the second condition certain modifications or extensions to the local breakout related signaling are needed. For the first type of embodiments the IMSI is included in the RRC message 62 that carries the local breakout radio bearer request. For the second type of embodiments it is more complex. When the method utilizing the NAS ATTACH REQUEST message with a new EPS attach type (‘stand-alone local breakout operation attach’), it is sufficient to mandate that the UE 2, for this type of attach, includes the IMSI—and not a GUTI—as its identity. When the first variant of the second type of embodiments is utilized, the IMSI should be included in the dedicated local breakout radio bearer establishment request message. When the second variant of the second type of embodiments is utilized, either the NAS ATTACH REQUEST message or the NAS PDN CONNECTIVITY REQUEST message sent together with it can carry the desired identity. As described for the “dedicated-EPS-attach-type” method, the UE 2 can be mandated to include the IMSI as its identity in the NAS ATTACH REQUEST message, when requesting the local breakout bearer 22. Alternatively the IMSI could be included in the NAS PDN CONNECTIVITY REQUEST message carrying the local breakout bearer request indication. When the third variant of the second type of embodiments is utilized, the IMSI should be included in the NAS BEARER RESOURCE ALLOCATION REQUEST carrying the local breakout bearer request indication. With these extensions/modifications in place the home base station 1 can check the received IMSI against its access list and reject local breakout bearer requests from illegitimate UEs 2. Note however, that with this method the IMSI is not authenticated, so a malicious (illegitimate) user can still get around this access control by providing a false IMSI to the home base station 1 (but the method provides at least some level of security since IMSI spoofing is not an easy task to perform).

Another kind of access control could be achieved by introducing a PIN code or password that the UE 2 must supply to the home base station 1 in order to be allowed access. The home base station owner could enter the PIN code or password directly into the home base station 1. Alternatively the PIN code or password could be configured via O&M (after the home base station owner has entered the PIN code or password into an O&M node, e.g. via a web interface). Yet an alternative is that the PIN code or password comes preconfigured or hardcoded when the home base station 1 is delivered. To prepare a UE 2 to be allowed access, the user must enter (e.g. manually) the PIN code or password into the UE 2, where it can be used once or stored to be reused at later occasions. To convey the PIN code (or password) to the home base station 1 the UE 2 would include it in one of the messages used to request the local breakout bearer 22, either as a separate parameter or integrated in one of the existing parameters, e.g. as a part of a special APN value.

A much higher level of security could of course be achieved if regular EPS authentication and encryption key generation algorithms could be leveraged, but this would require attaching to the 3GPP core network 15. A potential workaround could be to first attach to the 3GPP core network 15, authenticate and establish radio interface encryption, establish the local breakout bearer 22 between the UE 2 and the home base station 1 and then detach from the 3GPP core network 15, but keep the local breakout bearer 22 between the UE 2 and the home base station 1. Alternatively the UE 2 may detach from the 3GPP core network 15 (but both the UE 2 and the home base station 1 keep the established security contexts) before establishing the local breakout bearer 22. This also requires that the UE 2 does not encrypt the NAS messages in the regular manner. Normally NAS messages are encrypted between the UE 2 and the MME, so if the NAS messages are to be interpreted by the home base station 1 (as in the second type embodiments) they must not be encrypted in the regular manner. Either the UE 2 has to send them unencrypted or use the encryption normally intended for RRC signaling.

Another possible workaround would be to use a new EPS attach type in the NAS ATTACH REQUEST message (or another indication in an existing NAS message or even an entirely new NAS message) which would trigger the MME to only authenticate and provide encryption keys and then do nothing more. That is, the MME would not really attach the UE 2 and it would not create any state information (and thus no UE context). The only result of this MME involvement would be that the UE 2 is authenticated and that encryption is established between the UE 2 and the home base station 1.

Furthermore, with these workarounds leveraging the EPS security procedures, access control, in terms of whether the UE 2 is allowed to access this particular home base station 1, can be performed by the MME as is likely to be the case for regular home base station operation. Alternatively, IMSI based access control based on IMSI, PIN or password can be performed by the home base station 1 as described above. However, the IMSI based access control requires that the home base station 1 knows that the IMSI it uses for the access control is the same IMSI as was used in the authentication procedure by the MME. To ensure this the UE 2 must send the IMSI (and not the GUTI) in the NAS ATTACH REQUEST message (or new NAS message), so that the home base station 1 can snoop it.

An alternative way to leverage EPS Authentication and Key Agreement (AKA) mechanisms without involving the MME would be that the home base station 1 (instead of the MME) initiates the procedure towards the UE 2 and communicates with the operator's HSS/AAA server via a AAA protocol (e.g. Diameter) through the Internet or via the IPsec tunnel 13 and the transport network in the operator's network. To enable the home base station 1 to act as a AAA client and communicate with the operator's HSS/AAA server the home base station 1 must be configured (preferably via O&M at installation) with an FQDN (or IP address) of the operator's HSS/AAA server. Towards the UE 2 the home base station 1 would use EAP-AKA carried in PANA to carry out the authentication and encryption key establishment procedure. A suitable choice of AAA protocol could be the Diameter EAP Application or RADIUS with support for EAP. Alternatively, the home base station 1 emulates the MME during the AKA procedure and uses the NAS messages that normally conveys the AKA procedure as well as initiates encryption. In this case the home base station 1 would use a Diameter application adapted for use with 3GPP networks toward the HSS/AAA server.

Yet a way to provide security to the scenario where local breakout traffic is used without UE attachment to the core network 15 is to use IKE or IKEv2 locally between the UE 2 and the home base station 1 based on, e.g., pre-shared keys or cryptographic certificates.

Pre-shared key based AKA could also be run locally between the UE 2 and the home base station 1 using EAP-AKA carried in PANA.

A simple way to avoid backwards compatibility problems with home base stations which do not support local breakout or which support another local breakout method than the UE 2) is to let the home base station 1 announce its local breakout support in the broadcast system information. Then the UE 2 can adapt to the home base station's capabilities (or refrain from using local breakout in case it does not understand the local breakout capability indications in the system information or if the UE 2 and the home base station 1 are not compatible (i.e. the local breakout capabilities of the UE 2 and the home base station 1 do not match) or if the UE 2 for other reasons is not satisfied with the local breakout capabilities of the home base station 1). Another way to deal with backwards compatibility is to accept that the home base station 1 may not understand the UE's local breakout related messages and/or indications. For the first type of embodiments of the present invention this would mean that the home base station 1 would probably ignore a new dedicated RRC message for local breakout radio bearer request which the home base station 1 does not understand. In the absence of the expected response (possibly after a number of retries) the UE 2 would conclude the home base station 1 does not support the desired local breakout mechanism and could then choose to either try to establish a regular bearer to the 3GPP core network 15 instead or altogether abandon the bearer establishment. For the second type of embodiments of the present invention backwards compatibility with this approach depends on how the MME handles unknown, unforeseen, and erroneous NAS protocol data. If the MME can be made to ignore unknown/non-understandable message parameters or parameter values (or use default interpretations when appropriate) then backwards compatibility is rather easily achieved. If the home base station 1 forwards local breakout related NAS messages, which it should have intercepted, to the MME, then the MME may interpret them as regular messages and respond to them as such. From the lack of the expected information in the response message(s) the UE 2 can then infer that the home base station 1 does not support the assumed local breakout mechanism and that the response message(s) come(s) from the MME. The UE 2 can then choose to either continue the procedure and establish a regular bearer (for non-local breakout traffic) or abort the bearer establishment.

Although according to embodiments of the present invention the UE 2 controls which traffic should be locally broken out and which traffic should be treated as regular 3GPP traffic 15, the operator may still exercise an overall control of the local breakout functionality in general. Via O&M means an operator may for instance control whether the local breakout functionality in the home base station 1 should be enabled or disabled. This enable/disable control could be conditional e.g. based on day of week and/or time of day. It could also be more granular and distinguish between local breakout for local CPE network traffic and local breakout for Internet access, such that local breakout functionality is enabled for one of the traffic types but not for the other. An even more fine-grained control could download packet filters to the home base station 1, specifying e.g. which destination addresses which are allowed to be locally broken out or which destination addresses that must not be locally broken out.

FIG. 17 is a schematic block diagram of an O&M node 170 according to an embodiment of the present invention. The O&M node 170 comprises a control unit 171 which is adapted to communicate with the home base station 1 to enable or disable the home base station for local breakout transportation.

Another approach to operator control would be to specify in subscriber data whether a subscriber is (conditionally (e.g. based on time of day or which home base station 1 (or CSG ID) that is used) or unconditionally) allowed to use local breakout functionality or not. The subscriber data would be downloaded to the MME (together with other subscriber data) from the HSS as a result of a network attachment or a tracking area update and the MME would in turn instruct the home base station 1 accordingly through an appropriate S1AP message, e.g. a S1AP INITIAL CONTEXT SETUP REQUEST message (including the instructions in one or more new IE(s)).

The embodiments of the invention which have been described in detail above are based on an EPS (SAE/LTE) context and that the home base station 1 is a HeNB. The person skilled in the art will however realize that it is straightforward to adapt the above described embodiments to 3G and HNBs. Corresponding messages and parameters can be utilized in 3G protocols too.

In order to adapt the first type of embodiments to 3G new 3G RRC messages can be introduced for local breakout bearer establishment in the same manner as described above in terms of LTE RRC messages. Alternatively, new indications in existing messages could be utilized, e.g. in a 3G RRC RRC CONNECTION REQUEST message or a 3G RRC MEASUREMENT REPORT message.

In order to adapt the second type of embodiments of the present invention to 3G, the NAS messages could be replaced by corresponding 3G GPRS session management messages. For the first variant of the second type of embodiments new 3G GPRS session management messages can be introduced for local breakout bearer establishment in the same manner as described above in terms of EPS NAS messages. For the second variant of the second type of embodiments the NAS PDP CONNECTIVITY REQUEST message could be replaced by a 3G ACTIVATE PDP CONTEXT REQUEST message (with a special APN value or a special NSAPI or LLC SAPI value (instead of a special EPS bearer identity value) or a special QoS indication) or a 3G ACTIVATE SECONDARY PDP CONTEXT REQUEST message (with a special NSAPI or LLC SAPI value (instead of a special EPS bearer identity value) or a special QoS indication). For the third variant of the second type of embodiments the NAS BEARER RESOURCE ALLOCATION REQUEST message could be replaced by a 3G MODIFY PDP CONTEXT REQUEST message (with a special LLC SAPI value or a special QoS indication) or a 3G ACTIVATE SECONDARY PDP CONTEXT REQUEST message (with a special NSAPI or LLC SAPI value (instead of a special EPS bearer identity value) or a special QoS indication).

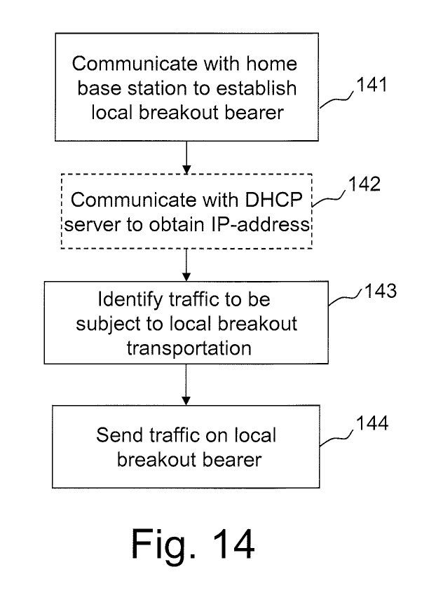

In the different embodiments of the present invention it is the UE 2 that performs the separation of traffic that is to be subject to local breakout transportation from traffic that is to pass the core network 15 by means of sending traffic that is to be subject to local breakout transportation to the home base station 1 on the established local breakout bearer 22. This procedure is illustrated in FIG. 14, which is a flow diagram illustrating a method in the UE 2 according to an embodiment of the present invention. In step 141 the UE 2 communicates with the home base station 1 to establish the local breakout bearer 22, according to any of the different establishment procedures described in detail above. If a dedicated IP address is to be used for the local breakout traffic this IP address may be obtained as an integral part of the step 141 of establishing the local breakout bearer 22 or separately in a step 142 in which the UE communicates with a DHCP server to obtain the dedicated IP-address, as described in detail above. In a step 143 the UE identifies uplink traffic to be subject to local breakout transportation and in a step 144 the UE sends the identified uplink traffic to the home base station 1 on the established local breakout bearer 22. It is to be noted that the step 141 may be triggered by the UE identifying uplink traffic that is to be subject to local breakout transportation, such that step 143 is in fact carried out before step 141. But the identification of uplink traffic to be subject to local transportation is also carried out continuously in the UE while uplink traffic is being generated. It is also possible that the step 141 is triggered as soon as the UE is connected to the home base station 1, irrespective of whether any uplink traffic has been identified for local breakout transportation or not.

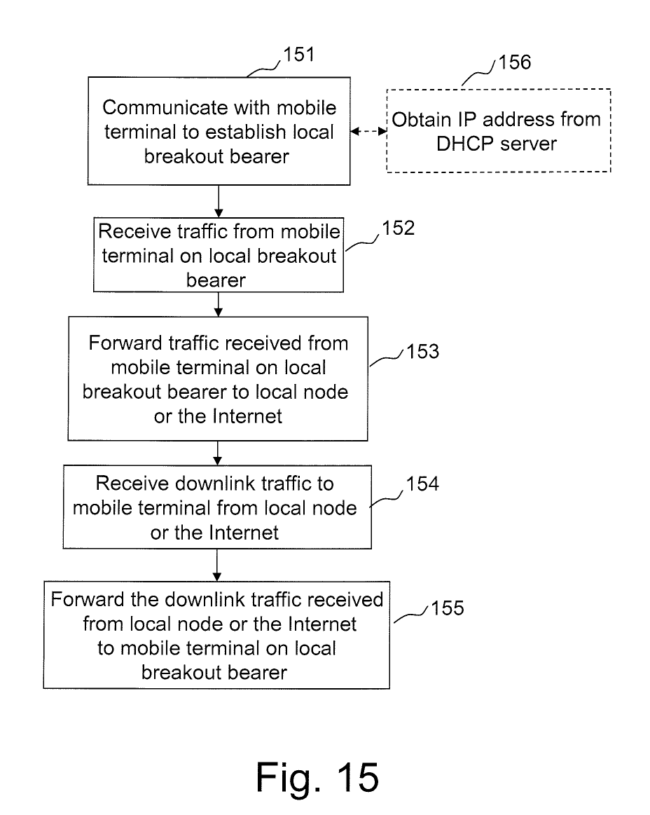

FIG. 15 is a flow diagram illustrating a method according to an embodiment of the present invention which may be performed in the home base station 1 in connection with local breakout operation. In a step 151 the home base station is communicating with the UE 2 to establish the local breakout bearer 22. If the UE has requested that it expects to receive a dedicated IP address for local breakout traffic, the home base station may also communicate with a DHCP server to obtain such a dedicated IP address on behalf of the UE, which is illustrated by a step 156. The different options of providing the UE with a dedicated IP address for local breakout traffic has been described in detail above. After establishment of the local breakout bearer, the home base station 1 can start receiving uplink traffic from the mobile terminal on the local breakout bearer, step 152. In a step 153, the home base station 1 forwards the traffic that is received from the mobile terminal on the local breakout bearer according to local breakout transportation, which means either forwarding to a local node 4 over the local CPE network 20 or to the Internet 21 via the access network 14. In both cases this traffic is forwarded outside of the IPsec tunnel 13 so that it does not pass the core network 15. Downlink traffic which the home base station receives from a local node in the local CPE network 20 or from the Internet outside of the IPsec tunnel 13 in a step 154, is forwarded to the UE on the local breakout bearer 22.

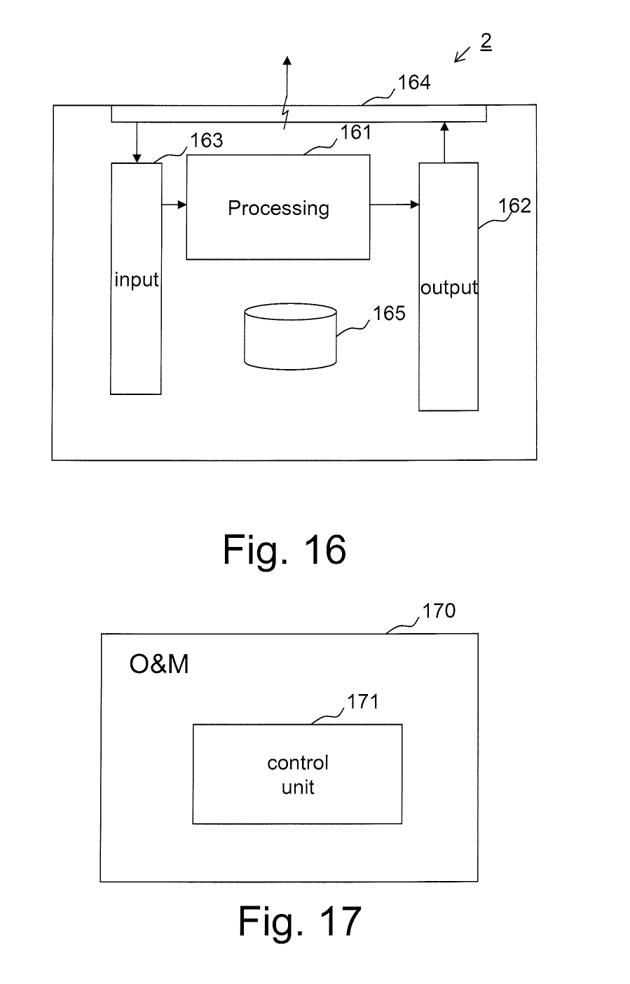

FIG. 16 is a schematic block diagram that illustrates an embodiment of a mobile terminal (UE) 2 according to the present invention. The mobile terminal 2 comprises a radio interface 164 by means of which the mobile terminal is able to communicate with e.g. the home base station. The mobile terminal 2 further includes an input unit 163 and an output unit 162 adapted to respectively receive and forward data packets via the interface 164. A processing unit 161 of the mobile terminal 2 is adapted to perform the above mentioned steps 141 and 143 (and possibly also optional step 142). FIG. 16 also illustrates that the mobile terminal 2 may include a storage unit for storing configuration information that specify for which traffic local breakout transportation is preferred. The person skilled in the art will from the description herein understand how the different units of the mobile terminal 2 can be implemented using hardware, firmware and/or software.

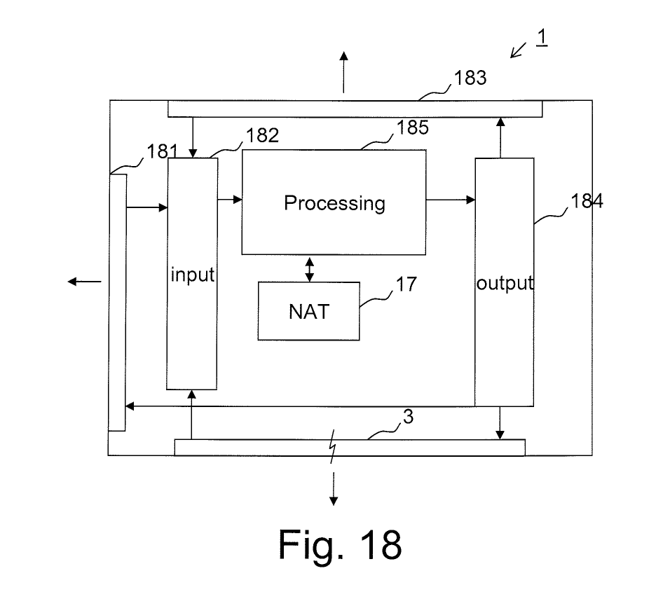

FIG. 18 is a schematic block diagram that illustrates an embodiment of a home base station 1 according to the present invention. The home base station 1 comprises a radio interface 3 by means of which the home base station is able to communicate with one or several mobile terminals (UEs). The home base station also has interfaces 181 and 183 through which the home base station can connect to a number of local nodes and a core network of a mobile telecommunications system (e.g. the 3GPP core network 15) and the Internet 21 via the access network 14. It is to be noted that depending on the application scenario the interfaces 181 and 183 may be combined or partly combined. For example in the first scenario described above the home base station 1 will use the same interface for sending packets to the Internet 21 as it uses for sending packets to local nodes 4. The home base station further includes an input unit 182 and an output unit 184 adapted to respectively receive and forward data packets via the interfaces. A processing unit 185 of the home base station 1 is adapted to perform the above mentioned step 151 (and possibly also optional step 156). FIG. 18 also illustrates that the home base station may include a NAT 17 as discussed. In addition, the home base station may include an ALG, although this is not illustrated in FIG. 18. The person skilled in the art will from the description herein understand how the different units of the home base station 1 can be implemented using hardware, firmware and/or software.

In the drawings and specification, there have been disclosed typical preferred embodiments of the invention and, although specific terms are employed, they are used in a generic and descriptive sense only and not for purposes of limitation, the scope of the invention being set forth in the following claims.

### SUMMARY OF ABBREVIATIONS USED HEREIN

3G 3rd Generation
3GPP 3rd Generation Partnership Project
AAA Authentication, Authorization & Accounting
ADSL Asymmetric Digital Subscriber Line
AKA Authentication and Key Agreement
ALG Application Level Gateway/Application Layer Gateway
APN Access Point Name
ARP Address Resolution Protocol
AuC Authentication Center
BB Broadband
CPE Customer Premises Equipment
CSG Closed Subscriber Group
CSG ID Closed Subscriber Group Identity
DHCP Dynamic Host Configuration Protocol
DNS Domain Name System
DSL Digital Subscriber Line
EAP Extensible Authentication Protocol
EPS Evolved Packet System
ESP Encapsulating Security Payload
E-UTRAN Evolved Universal Terrestrial Radio Access Network
FQDN Fully Qualified Domain Name
GGSN Gateway GPRS Support Node
Gi The interface between a UMTS GGSN and an external network.
GPRS General Packet Radio Service
GUTI Globally Unique Temporary Identity
HeNB Home eNode B
HN Home (e)Node B (i.e. either Home Node B or Home eNode B)
HNB Home Node B
HSS Home Subscriber Server
ID Identity
IE Information Element
IEEE Institute of Electrical and Electronics Engineers
IKE Internet Key Exchange
IKEv2 Internet Key Exchange version 2
IMSI International Mobile Subscriber Identity
IP Internet Protocol
IPsec IP security (as defined in RFC 4301)

IPv4 Internet Protocol version 4
IPv6 Internet Protocol version 6
Iu The interface between an RNC and the core network in UMTS.
L2 Layer 2
LAN Local Area Network
LBO Local Breakout
LLC Logical Link Control
LLC SAPI Logical Link Control Service Access Point Identifier
LTE Long Term Evolution
MAC Media Access Control
MGW Media Gateway
MIPv6 Mobile IPv6
MME Mobility Management Entity
MSC Mobile Switching Center
NAS Non-Access Stratum
NAT Network Address Translation/Translator
NSAPI Network Service Access Point Identifier
O&M Operation and Maintenance
PANA Protocol for Carrying Authentication for Network Access
PDCP Packet Data Convergence Protocol
PDN Packet Data Network
PIN Personal Identification Number
QoS Quality of Service
RADIUS Remote Authentication Dial In User Service
RFC Request For Comments
RLC Radio Link Control
RNC Radio Network Controller
RRC Radio Resource Control
S1 The interface between E-UTRAN and the core network in EPS (e.g. between an eNode B and an MME/S-GW).
S1 AP S1 Application Protocol (A protocol used between an (H)eNB and an MME.)
SAE System Architecture Evolution
SAPI Service Access Point Identifier
SGSN Serving GPRS Support Node
SGi The interface between an EPS PDN Gateway and an external network
S-GW Serving Gateway
SGSN Serving GPRS Support Node
TS Technical Specification
UE User Equipment
UMTS Universal Mobile Telecommunications System
UPnP Universal Plug and Play
USIM Universal Subscriber Identity Module
WLAN Wireless Local Area Network
xDSL X Digital Subscriber Line (referring to the DSL family of technologies where “X” stands for any of the letters that can be placed before “DSL”, e.g. A or V)

1. A method in a mobile terminal for forwarding of traffic, wherein said mobile terminal has a radio connection to a home base station, the home base station has a connection to a local network comprising a number of local nodes, a connection to a core network of a mobile telecommunications system via an access network, and a connection to the Internet via the access network, wherein said method comprises:
identifying uplink traffic to be subject to local breakout transportation, wherein local breakout transportation implies forwarding the uplink traffic to a local node and/or the Internet without passing the core network;
communicating with the home base station using signaling to establish a dedicated local breakout bearer for traffic subject to local breakout transportation, wherein the local breakout bearer is a radio bearer that extends between the mobile terminal and the home base station; and
sending said identified uplink traffic to the home base station on the established local breakout bearer.

2. The method according to claim 1, wherein the home base station is a 3G Home Node B or an EPS/LTE Home eNode B, and the core network is a 3GPP core network.

3. The method according to claim 1, wherein said step of communicating with the home base station to establish the local breakout bearer includes receiving an IP address, which is dedicated for traffic subject to local breakout transportation, from the home base station and wherein said step of sending includes using said received IP address as source address for the uplink traffic sent on the local breakout bearer.

4. The method according to claim 1, further including a step of communicating with a DHCP, Dynamic Host Configuration Protocol, server to obtain an IP address, which is dedicated for traffic subject to local breakout transportation, and wherein said step of sending includes using said obtained IP address as source address for the uplink traffic sent on the local breakout bearer.

5. The method according to claim 1, wherein said step of communicating with the home base station to establish the local breakout bearer includes sending a request message for establishment of the local breakout bearer to the home base station, which request message includes preference information specifying preferences regarding the establishment of the local breakout bearer.

6. The method according to claim 5, wherein said preference information includes information on conditions for establishment, which specify if the local breakout bearer is to be established unconditionally,
only if local breakout transportation of traffic to the local network can be arranged,
only if local breakout transportation of traffic to the Internet can be arranged, only if at least one of local breakout transportation of traffic to the local network and local breakout transportation of traffic to the Internet can be arranged, or
only if both local breakout transportation of traffic to the local network and local breakout transportation of traffic to the Internet can be arranged.

7. The method according to claim 5, wherein said preference information includes information on IP address allocation preferences, which comprises one or several of the following types of information:
information that the mobile terminal expects to use an IP address allocated by the core network for the local breakout bearer;
information that the mobile terminal expects to get a dedicated IP address allocated for the local breakout bearer from a DHCP server or from the home base station; and/or
information regarding need for network address translation, NAT, support from the home base station for traffic carried on the local breakout bearer.

8. The method according to claim 1, wherein said step of communicating with the home base station to establish the local breakout bearer is performed by means of exchanging one or several Radio Resource Control, RRC, signaling messages between the mobile terminal and the home base station.

9. The method according to claim 8, wherein said one or several RRC signaling messages includes a RRC type message dedicated for local breakout bearer establishment request, a RRCConnectionRequest message, or a MeasurementReport message.

10. The method according to claim 1, wherein said step of communicating with the home base station to establish the local breakout bearer is performed by means of exchanging one or several Non-Access Stratum, NAS, signaling messages between the mobile terminal and the home base station.

11. The method according to claim 10, wherein said one or several NAS signaling messages includes a NAS type message dedicated for local breakout bearer request, a PDN CONNECTIVITY REQUEST message, or a BEARER RESOURCE ALLOCATION REQUEST message.

12. The method according to claim 1, wherein traffic is identified for local breakout transportation in accordance with configuration information in the mobile terminal that specify for which traffic local breakout transportation is preferred.

13. The method according to claim 1, wherein traffic is identified for local breakout transportation in accordance with an indication provided by the user of the mobile terminal regarding traffic for which local breakout transportation is preferred.

14. A method in a home base station for forwarding of traffic, wherein said home base station has a connection to at least one mobile terminal over a radio interface, a connection to a local network comprising a number of local nodes, a connection to a core network of a mobile telecommunications system via an access network, and a connection to the Internet via the access network, wherein said method comprises:
communicating with the mobile terminal using signaling to establish a dedicated local breakout bearer for traffic subject to local breakout transportation, wherein local breakout transportation implies forwarding the uplink traffic to a local node and/or the Internet without passing the core network and wherein the local breakout bearer is a radio bearer that extends between the mobile terminal and the home base station;
receiving uplink traffic from the mobile terminal on the established local breakout bearer; and
forwarding the uplink traffic received on the local breakout bearer according to local breakout transportation.

15. The method according to claim 14, wherein the home base station is a 3G Home Node B or an EPS/LTE Home eNode B, and the core network is a 3GPP core network.

16. The method according to claim 14, wherein said step of communicating with the mobile terminal to establish the local breakout bearer includes sending an IP address, which is dedicated for traffic subject to local breakout transportation to the mobile terminal.

17. The method according to claim 14, further including a step of communicating with a DHCP, Dynamic Host Configuration Protocol, server to obtain an IP address, which is dedicated for traffic subject to local breakout transportation.

18. The method according to claim 14, wherein said step of communicating with the mobile terminal to establish the local breakout bearer includes receiving a request message for establishment of the local breakout bearer, which request message includes preference information specifying preferences regarding the establishment of the local breakout bearer, and establishing the local breakout bearer in accordance with the preference information.

19. The method according to claim 14, wherein said step of communicating with the mobile terminal to establish the local breakout bearer is performed by means of exchanging one or several Radio Resource Control, RRC, signaling messages between the mobile terminal and the home base station.

20. The method according to claim 19, wherein said one or several RRC signaling messages includes a RRC type message dedicated for local breakout bearer request, a RRCConnectionRequest message, or a MeasurementReport message.

21. The method according to claim 14, wherein said step of communicating with the mobile terminal to establish the local breakout bearer is performed by means of exchanging one or several Non-Access Stratum, NAS, signaling messages between the mobile terminal and the home base station.

22. The method according to claim 21, wherein said one or several NAS signaling messages includes a NAS type message dedicated for local breakout bearer request, a PDN CONNECTIVITY REQUEST message, or a BEARER RESOURCE ALLOCATION REQUEST message.

23. The method according to claim 21, wherein exchanging one or several NAS signaling messages between the mobile terminal and the home base station comprises:
intercepting NAS signaling from the mobile terminal to determine if a NAS message relates to local breakout bearer establishment;
processing the NAS message within the home base station, if the NAS message is related to local breakout bearer establishment; and
forwarding the NAS message to the core network), if the NAS message is not related to local breakout bearer establishment.

24. The method according to, further comprising a step of forwarding downlink traffic received from the local network and/or the Internet to the mobile terminal on the local breakout bearer.

25. The method according to claim 14, further comprising a step of communicating with an operation and maintenance system to receive control information that enable or disable local breakout transportation functionality in the home base station.

26. A mobile terminal for use in a mobile telecommunications system, wherein said mobile terminal comprises:
a radio interface adapted for connection to a home base station, wherein the home base station has a connection to a local network comprising a number of local nodes, a connection to a core network of the mobile telecommunications system via an access network, and a connection to the Internet via the access network, comprising:
a processing unit adapted to identify uplink traffic to be subject to local breakout transportation, wherein local breakout transportation implies forwarding the uplink traffic to a local node and/or the Internet without passing the core network; and to
communicate with the home base station using signaling to establish a dedicated local breakout bearer for traffic subject to local breakout transportation, wherein the local breakout bearer is a radio bearer that extends between the mobile terminal and the home base station; and
an output unit adapted to send said identified uplink traffic to the home base station on the established local breakout bearer.

27. The mobile terminal according to claim 26, wherein the home base station is a 3G Home Node B or an EPS/LTE Home eNode B, and the core network is a 3GPP core network.

28. The mobile terminal according to claim 26, wherein said mobile terminal further includes an input unit adapted to receive an IP address, which is dedicated for traffic subject to local breakout transportation, from the home base station and wherein said output unit is adapted to use said received IP address as source address for the uplink traffic sent on the local breakout bearer.

29. The mobile terminal according to claim 26, wherein said processing unit is further adapted to communicate with a DHCP, Dynamic Host Configuration Protocol, server to obtain an IP address, which is dedicated for traffic subject to local breakout transportation, and wherein said output unit is adapted to use said obtained IP address as source address for the uplink traffic sent on the local breakout bearer.

30. The mobile terminal according to claim 26, wherein said processing unit and output unit are further adapted to create and send a request message for establishment of the local breakout bearer to the home base station, which request message includes preference information specifying preferences regarding the establishment of the local breakout bearer.

31. The mobile terminal according to claim 30, wherein said preference information includes information on conditions for establishment, which specify if the local breakout bearer is to be established unconditionally,
only if local breakout transportation of traffic to the local network can be arranged,
only if local breakout transportation of traffic to the Internet can be arranged, only if at least one of local breakout transportation of traffic to the local network and local breakout transportation of traffic to the Internet can be arranged, or
only if both local breakout transportation of traffic to the local network and local breakout transportation of traffic to the Internet can be arranged.

32. The mobile terminal according to claim 30, wherein said preference information includes information on IP address allocation preferences, which comprises one or several of the following types of information:
information that the mobile terminal expects to a use an IP address allocated by the core network for the local breakout bearer;
information that the mobile terminal expects to get a dedicated IP address allocated for the local breakout bearer from a DHCP server or from the home base station; and
information regarding need for network address translation, NAT, support from the home base station for traffic carried on the local breakout bearer.

33. The mobile terminal according to claim 26, wherein said processing unit is adapted to communicate with the home base station to establish the local breakout bearer by means of exchanging one or several Radio Resource Control, RRC, signaling messages between the mobile terminal and the home base station.

34. The mobile terminal according to claim 33, wherein said one or several RRC signaling messages includes a RRC type message dedicated for local breakout bearer request, a RRCConnectionRequest message, or a MeasurementReport message.

35. The mobile terminal according to claim 26, wherein said processing unit is adapted to communicate with the home base station to establish the local breakout bearer by means of exchanging one or several Non-Access Stratum, NAS, signaling messages between the mobile terminal and the home base station.

36. The mobile terminal according to claim 35, wherein said one or several NAS signaling messages includes a NAS type message dedicated for local breakout bearer request, a PDN CONNECTIVITY REQUEST message, or a BEARER RESOURCE ALLOCATION REQUEST message.

37. The mobile terminal according to claim 26, wherein the mobile terminal further comprises a storage unit for storing configuration information that specify for which traffic local breakout transportation is preferred and wherein the processing unit is adapted to identify traffic for local breakout transportation in accordance with said configuration information.

38. The mobile terminal according to claim 26, wherein the processing unit is further adapted to identify traffic for local breakout transportation in accordance with an indication provided by the user of the mobile terminal regarding traffic for which local breakout transportation is preferred.

39. A home base station for use in a mobile telecommunications system, wherein said home base station comprises:
a radio interface adapted for connection to at least one mobile terminal;
an interface adapted for connection to a local network comprising a number of local nodes;
an interface adapted for connection to a core network of the mobile telecommunications system via an access network; and
an interface adapted for connection to the Internet via the access network, wherein the home base station further comprises:
a processing unit adapted to communicate with the mobile terminal using signaling to establish a dedicated local breakout bearer for traffic subject to local breakout transportation, wherein local breakout transportation implies forwarding the uplink traffic to a local node and/or the Internet without passing the core network and wherein the local breakout bearer is a radio bearer that extends between the mobile terminal and the home base station;
an input unit adapted to receive uplink traffic from the mobile terminal on the established local breakout bearer; and
an output unit adapted to forward the uplink traffic received on the local breakout bearer according to local breakout transportation.

40. The home base station according to claim 39, wherein the home base station is a 3G Home Node B or an EPS/LTE Home eNode B, and the core network is a 3GPP core network.

41. The home base station according to claim 39, wherein said processing unit is adapted to send an IP address, which is dedicated for traffic subject to local breakout transportation to the mobile terminal.

42. The home base station according to claim 39, wherein said processing unit is further adapted to communicate with a DHCP, Dynamic Host Configuration Protocol, server to obtain an IP address, which is dedicated for traffic subject to local breakout transportation.

43. The home base station according to claim 39, wherein said processing unit is further adapted to receive and process a request message for establishment of the local breakout bearer from the mobile terminal, which request message includes preference information specifying preferences regarding the establishment of the local breakout bearer, and to establish the local breakout bearer in accordance with the preference information.

44. The home base station according to claim 39, wherein said processing unit is adapted to communicate with the mobile terminal to establish the local breakout bearer by means of exchanging one or several Radio Resource Control, RRC, signaling messages between the mobile terminal and the home base station.

45. The home base station according to claim 44, wherein said one or several RRC signaling messages includes a RRC type message dedicated for local breakout bearer request, a RRCConnectionRequest message, or a MeasurementReport message.

46. The home base station according to claim 39, wherein said processing unit is adapted to communicate with the mobile terminal to establish the local breakout bearer by means of exchanging one or several Non-Access Stratum, NAS, signaling messages between the mobile terminal and the home base station.

47. The home base station according to claim 46, wherein said one or several NAS signaling messages includes a NAS type message dedicated for local breakout bearer request, a PDN CONNECTIVITY REQUEST message, or a BEARER RESOURCE ALLOCATION REQUEST message.

48. The home base station according to claim 46, wherein said processing unit is further adapted to
intercept NAS signaling from the mobile terminal to determine if a NAS message relates to local breakout bearer establishment;
process the NAS message, if the NAS message is related to local breakout bearer establishment; and
forward the NAS message to the core network, if the NAS message is not related to local breakout bearer establishment.

49. The home base station according to claim 39, wherein said output unit is further adapted to forward downlink traffic received from the local network and/or the Internet to the mobile terminal on the local breakout bearer.

50. The home base station according to claim 39, wherein said processing unit is further adapted to communicate with an operation and maintenance system to receive control information and to enable or disable local breakout transportation functionality in the home base station in accordance with said control information.

51. An operation and maintenance node for use in an operation and maintenance system of a telecommunications system, wherein the node comprises a control unit which is adapted to communicate with a home base station to enable or disable the home base station for local breakout transportation, wherein local breakout transportation implies forwarding traffic to a local node and/or the Internet without passing a core network of a mobile telecommunications system.

52. A method in an operation and maintenance node of an operation and maintenance system of a telecommunications system, comprising a step of sending control information to a home base station to enable or disable the home base station for local breakout transportation, wherein local breakout transportation implies forwarding traffic to a local node and/or the Internet without passing a core network of a mobile telecommunications system.
